(19) United States
(12) Patent Application Publication
(10) Pub. No.: US 2021/0358256 A1
(43) Pub. Date: Nov. 18, 2021

(54) STORAGE AND DISPENSING OF CONSUMER GOODS

(71) Applicant: Patrick LAVERTY, JOhannesburg (ZA)

(72) Inventor: Patrick LAVERTY, JOhannesburg (ZA)

(21) Appl. No.: 17/286,272

(22) PCT Filed: Oct. 16, 2019
(86) PCT No.: PCT/IB2019/058825

§ 371 Date: Apr. 16, 2021

(30) Foreign Application Priority Data
Oct. 16, 2018 (ZA) 2018/06876
Oct. 16, 2018 (ZA) 2018/06877
Nov. 12, 2018 (ZA) 2018/07565

(51) Int. Cl. G07F 11/36; G07F 11/28; G07F 13/10

(52) U.S. Cl. CPC G07F 11/36; G07F 13/10; G07F 11/28

(57) ABSTRACT

A beverage container storage and dispensing device (“dispensing device”) (10) for storage and dispensing of beverage containers containing a beverage is provided. The dispensing device comprises a shell (12) that has a hollow interior. The dispensing device also comprises, located inside of the shell, a helical beverage container storage and dispensing track (22) (“dispensing track”). The dispensing track extends in a spiralling manner around and along a central support structure (24). The dispensing track defines a channel that is configured to receive and thus locate, in use, a plurality of beverage containers (19), each containing a beverage, in a substantially upright configuration in series there along such that, in use, beverage containers located higher on the dispensing track move downwardly along the dispensing track when a beverage container located lower on the dispensing track is removed from the dispensing track.

### FIELD OF THE INVENTION

THIS INVENTION relates to storage and dispensing of consumer goods. More particularly, the invention relates to storage and dispensing of beverage containers that contain beverages. The invention provides a beverage container storage and dispensing device. The invention also provides a method of storing and dispensing beverage containers. The invention further provides a beverage container storage and dispensing system.

### SUMMARY OF THE INVENTION

IN ACCORDANCE WITH A FIRST ASPECT OF THE INVENTION IS PROVIDED a beverage container storage and dispensing device (“dispensing device”) for storage and dispensing of beverage containers containing a beverage, the dispensing device comprising a helical beverage container storage and dispensing track (“dispensing track”) that is configured to receive and thus locate, in use, a plurality of beverage containers, each containing a beverage, there along such that, in use, beverage containers located higher on the dispensing track move downwardly along the dispensing track when a beverage container located lower on the dispensing track is removed/unloaded from the dispensing track.

It would be appreciated that it would therefore be typical that, in use, the beverage containers of the plurality of beverage containers would be located in series, i.e. one after the other, along the dispensing track. Even more typically, they would abut against each other. This is, while included as a typical embodiment of the invention, not an absolute qualification on the scope of the invention.

It is expected that beverage containers would in use be removed/unloaded from the dispensing track one at a time, although this is also, while included as a typical embodiment of the invention, not an absolute qualification on the scope of the invention.

In this specification the term “beverage” broadly refers, without detracting from its dictionary meaning, to liquid drinks for human consumption, including but not limited to soft drinks, alcoholic drinks, and water.

Furthermore, in this specification the term “beverage container” broadly refers, without detracting from its dictionary meaning, to containers in which beverages are typically contained for consumption, including but not limited to cans and bottles. In the context of the invention, the most typical beverage container that would be relevant is a can. Thus, the plurality of beverage containers, in use, would typically be a plurality of cans. Although typical and thus included as an embodiment of the invention, it is not an absolute qualification on the scope of the invention and the invention is equally applicable to other beverage containers.

Still further, “helical” in the sense of “helical beverage container storage and dispensing track”, means, without detracting from its dictionary meaning, that the dispensing track has a helical, i.e. spiralling, configuration, extending between two spaced apart ends of the dispensing track. Preferably, the helical configuration of the dispensing track would be such that it has a constant radius, i.e. it does not have a radius that reduces or increases from one end of the dispensing track to the other.

Further still, “communication” as used in this specification with reference to electronic information signals and the like, includes electronic communication, i.e. communication using electronic signals, such as that implemented by a telecommunication system through communication networks, transmission systems, relay stations, tributary stations, data terminal equipment and the like, including broadband communication, radio communication, wi-fi communication, fixed line communication, etc.

The dispensing device may include a hollow shell, defining a hollow interior. The dispensing track may be located inside of the shell, with the shell thus accommodating the dispensing track.

The shell would typically be cylindrical, with a closed top and bottom. As such, the shell may have a cylindrical sidewall.

The shell may provide for the device to carry an ornamental or informative representation, such as branding, typically on a wrap-around member, such as a film or sleeve of polymeric material. When the shell is cylindrical, as described above, the cylindrical sidewall would typically be slightly inwardly offset from a rim of the top and bottom, thereby to provide a cavity complemental to a wrap-around sleeve that may be mounted to the sidewall in use, for displaying ornamental or informative features.

The shell may have any desired shape and configuration, provided that it is shaped and configured such that it can accommodate the dispensing track therein. It follows that the height and diameter of the shell would be selected with reference to the size of the dispensing track, and further with reference to other practical considerations, such as handling and space requirements. In one embodiment of the invention, the diameter of the shell may be up to 50 cm, typically up to 40 cm, e.g. 30 cm, and the height of the shell may be up to 1.5 m, typically up to 1 m, e.g. 90 cm. In other embodiments, the diameter can be larger than 50 cm.

It is expected that the diameter would ultimately be dictated by an operator/owner of the device, with reference to the abovementioned practical considerations.

Preferably, the shell would be shaped in the likeness of a beverage container, e.g. a bottle or a can. As shown in the exemplary embodiment of the invention discussed with reference to the drawings later on, the shell is preferably shaped in the likeness of a can. Other desired shapes of the shell, viewed in cross section, may be square, rectangular, oval or following the contour of a beverage bottle container.

The shell can be manufactured of any one of a variety of materials, e.g. metallic material or polymeric material.

As noted above, dispensing track would typically be located inside of the hollow interior of the shell. Thus, the dispensing track would be isolated, by the shell, from surrounds of the shell, and access to beverage containers located on, and along, the dispensing track, in use, would be restricted.

The shell may be insulated, specifically thermally insulated, to assist in maintaining a desired temperature in its interior. In this regard, the shell may include a thermal insulation layer in a wall thereof. Typically, when the shell includes a thermal insulation layer and is cylindrical, the layer would at least be provided in the sidewall of the shell.

The thickness of the thermal insulation layer may be selected depending on required efficacy and practical considerations, e.g. manufacturing considerations, ease of handling, and considerations relating to the location of installation, store space availability and/or use of the dispensing device. For example, the thermal insulation layer may have a thickness of up to 10 cm, more typically up to 5 cm.

The thermal insulation layer may be of a thermally insulating material, e.g. polyurethane.

Alternatively, the thermal insulation layer may also be configured as a vacuum formed wall, e.g. similar to the configuration of a thermos flask, i.e. double-walled with a vacuum in-between. This may apply to all walls of the shell that defines the interior within which the dispensing track is provided. In this regard it should be noted that the shell may define various divided interior volumes, including at least one for the dispensing track, and optionally one for the temperature control device described below.

The dispensing device may, in use, be located such that the dispensing track would be upright, with reference to a central axis thereof. It would be appreciated that the dispensing track would naturally define such an axis, in having a helical configuration.

The dispensing track may be an integrally formed dispensing track, or an assembled dispensing track. In the latter embodiment, the dispensing track would comprise sections that clip of bolt onto each other, to provide the dispensing track as illustrated. It would be appreciated that this flexibly allows the dispensing track to be configured to be of any desired length, and further allows greater ease of assembly and/or manufacturing.

In this regard, also in accordance with the invention, the shell, and more particularly its sidewall, may be an assembled sidewall, in that it comprises a plurality of assembled annular sections. It should be noted that “annular” is in this sense not limited to circular, but could be any closed geometric shape, e.g. oval, rectangular, etc. Circular is more typical, however. A top and bottom of the shell, which would be closed, may then also be components assembled with such a plurality of assembled annular sections. It would be appreciated that this flexibly allows the dispensing track to be configured to be of any desired length, the magnitude of which would be dictated by the length/height of the dispensing track.

Such flexibility is regarded as an advantage of the invention, considering the consequential variability of the length dimension of the device, more specifically of the shell, and, further, storage and maintenance advantages, e.g. that it allows for ease of access and maintenance, including to address blockages. Furthermore, it allows the dispensing device and the dispensing track (when an assembled dispensing track) to extend, e.g. through the roof of an establishment at which it is located, allowing for re-stocking, e.g. by drone as described herein, to take place without having to move the dispensing device.

Having a helical configuration, the dispensing track may extend in a spiralling manner between an operatively upper, or loading, end and an operatively lower, or unloading, end of the dispensing track. In this sense, “loading” refers to the action of loading the dispensing track with beverage containers and “unloading” refers to the action of unloading beverage containers from the dispensing track.

As would be appreciated from the description of the dispensing door, below, the action of unloading beverage containers from the dispensing track in the context of the invention does not necessarily effect, or is at least not necessarily regarded as amounting to, dispensing of beverage containers by/from the dispensing device. An additional step is preferably required in the invention, which would involve operation of the dispensing door as described below. That said, the invention does not absolutely exclude from its scope the possibility that unloading of beverage containers from the dispensing track may effect dispensing of beverage containers from the dispensing device. Ultimately, in at least one embodiment of the invention, the question of whether a beverage container has been dispensed or not, would be answered with reference to whether or not it is directly accessible to a consumer, for collection.

Configuration of the dispensing track may be such that movement of beverage containers there along is under force of gravity. The dispensing track may therefore typically be configured such that it allows free movement of beverage containers downwardly there along, in series and under force of gravity, as beverage containers located lower on the dispensing track are removed/unloaded from the dispensing track. For example, the dispensing track may have a downwardly inclined floor member, on which beverage containers are supported in use and along which beverage containers slide under gravity when a beverage container lower on the dispensing track is removed/unloaded from the dispensing track.

It would be appreciated that by holding, in use, a beverage container located on the dispensing track in its position to prevent it from moving along the dispensing track under the force of gravity, beverage containers located higher up along the dispensing track would also be held in their positions, provided that those beverage containers are in abutment with each other and in abutment with the beverage container that is being held. In use, the lowermost beverage container of a plurality of beverage containers located on the dispensing track would typically be a beverage container that is so held, e.g. by or in a dispensing door as hereinafter described.

Thus, as stated, with the dispensing track being located in an upright configuration in use, and being helical, movement of beverage containers along the dispensing track, in use, would most typically be under the force of gravity to fill a void left by a removed/unloaded beverage container. As such, under the force of gravity, unloading of a beverage container from the unloading end of the dispensing track would create a void at that end of the dispensing track, which would be filled by the next, remaining, beverage container, that would move into that space under the force of gravity, being urged in this regard by such movement of other remaining beverage containers which would also move, in unison with the first, i.e. lowermost, remaining beverage container. It would be appreciated that “remaining” in this sense means “remaining on the dispensing track”.

In being configured to receive and thus locate, in use, a plurality of beverage containers in series there along, the dispensing track may define a channel in which the beverage containers would be located, which channel would then, when provided, provide the inclined floor member hereinbefore described.

Preferably, the channel would be configured such that beverage containers can be located on and along the dispensing track in a substantially upright configuration, referring in this regard to the depth and width of the channel. In this sense, and in the sense of the specification generally, the term “substantially upright” includes vertical, but is not limited to vertical. Thus, in being located on and along the dispensing track, the beverage containers may be oriented at a slight angle relative to a fully upright, or vertical orientation.

Orienting beverage containers substantially, rather than fully, upright, may be required, in particular in order effectively to effect unloading of beverage containers from the dispensing track, e.g. onto/into a beverage container locating formation as hereinafter described, in an upright orientation. It would be appreciated that when such unloading occurs laterally, a beverage container unloaded from the dispensing track may fall over, if it was located vertically upright on the dispensing track and thereafter unloaded from it in a lateral sliding manner. Orienting beverage containers on the dispensing track such that they are angled away from the unloading end of the dispensing track, at least when arriving at the unloading end of the dispensing track, leaves some play for a beverage container unloaded from the dispensing track to move, e.g. tilt, relative to its fully upright configuration, due to its unloading momentum, without falling over, thereby ultimately to assume rest in a fully upright configuration on the beverage container locating member.

Thus, configuration of the dispensing track may be such that beverage containers located there along would be so located in a substantially upright configuration, with the width and depth of the dispensing track typically being such that a beverage container can snugly be received by the dispensing track in such a substantially upright configuration, while allowing for free movement of the container along the dispensing track under gravity as beverage containers located lower on the dispensing track are removed/unloaded from the dispensing track.

The dispensing device may include one or more additional helical dispensing tracks (“additional dispensing tracks”) of substantially identical configuration to that of the dispensing track described above. In this sense, the dispensing track described above would be the dispensing track that would have its unloading end at a dispensing door hereinafter described, i.e. being the lowermost dispensing track of the device, and/or would not be followed by any further dispensing tracks.

Such additional dispensing tracks, including the existing dispensing track, may be assembled or integrally formed. To accommodate larger beverage containers the angle of descent of such a dispensing track, and therefore its pitch, may be reduced/increased, as the case may be, but such that gravity-driven movement along it is still possible.

Typically, such additional dispensing tracks would be located above the lowermost dispensing track, i.e. the dispensing track as described above from which beverage containers are in use unloaded to be dispensed from the dispensing device. This would be recognised as constituting a stacked configuration of the dispensing track and the additional dispensing track/s.

Each additional dispensing track would then be configured for transfer, or unloading, of beverage containers, located thereon in use, to the dispensing track that is located below it. In this regard, the dispensing tracks would typically not lead into each other to provide a continuous dispensing track. More preferably, each additional dispensing track would terminate abruptly, above the next dispensing track, providing for vertical transfer, or unloading, of beverage containers located on a higher additional dispensing track to a following, lower, dispensing track, e.g. through an opening in a floor of each additional dispensing track.

Thus, configuration of the dispensing device in respect of the additional dispensing tracks may be such that beverage containers would in use also move along additional dispensing tracks in a sliding manner, as hereinbefore described, typically under gravity, until they get to an end of the additional dispensing track, where they would be transferred, or unloaded, to the next dispensing track on which they are located, e.g. by dropping vertically, under gravity, through an opening in the floor of the additional dispensing track.

It would be appreciated that configuration of the additional dispensing tracks to allow for transfer, or unloading, of beverage containers to the next dispensing track, e.g. by providing openings at unloading ends of the additional dispensing tracks, distinguishes the additional dispensing tracks structurally from what would be the lowermost dispensing track, as described above.

That said, the invention does not exclude a possibility that the dispensing device may be configured such that the lowermost dispensing track of a stacked configuration of dispensing tracks, or the only dispensing track if the device comprises only one dispensing track, is configured to provide for vertical unloading of beverage containers, e.g. to the dispensing door hereinafter described. This may also be through an opening defined in an end of the lowermost, or only, dispensing track. Thus, the invention includes an embodiment in which the dispensing track, that is not an additional dispensing track, provides for vertical unloading of beverage containers therefrom, rather than lateral unloading.

As would be appreciated from the description that follows, lateral unloading from the dispensing track to the dispensing formation would be more typical, however. Configuring the dispensing track for vertical unloading of beverage containers from the dispensing track to the dispensing formation is not excluded, however, and is regarded as a viable unloading approach.

The option to employ additional dispensing tracks is regarded as advantageous in allowing the dispensing device to be configured to accommodate beverage containers of different sizes, on the dispensing track. It would be appreciated that, when configured for a beverage container with a first height, H1, the dispensing track would have a pitch that optimises the capacity of the dispensing track. As such, the dispensing track would not, typically, be capable of accommodating a beverage container with a second height, H2, that is greater than H1. A conventional approach to address this problem in configuring the dispensing track to accommodate, instead, larger beverage containers, would be to increase the pitch of the dispensing track. In doing so, however, the capacity of the dispensing track would be negatively influenced, i.e. reduced. Thus, inventively, the present invention presents a solution of providing multiple helical dispensing tracks, thereby to maintain capacity when working with larger beverage containers.

The dispensing device may further include a support structure for supporting the dispensing track. The dispensing track may therefore be mounted to the support structure, thus being supported by it.

In one embodiment of the invention, the support structure may be a centrally located support structure, being centrally, i.e. co-axially, located with respect to the dispensing track. Thus, the dispensing track may extend in a spiralling manner around and along the support structure.

Preferably, the support structure is hollow, thus defining a hollow interior.

Also, the support structure is preferably apertured, thus being capable of allowing air to pass not only along, but also through it, and thus into the hollow interior of the shell. As described hereinafter in more detail, the support structure would, thus, play an additional functional role in promoting heat transfer/cooling in the device, in use.

As alluded to above, dispensing device may include a dispensing door, configured to dispense one or more beverage containers from the dispensing device. In this sense, dispensing is understood, as noted above, as broadly meaning to make available for collection by a consumer or a consumer intermediary (examples of the latter being a barman or waiter).

The dispensing door may be located in a dispensing opening in the shell, near the unloading end of the dispensing track.

In one embodiment, the dispensing door may simply be a hatch-like structure, which can be opened and closed, automatically or manually, selectively to gain access to the interior of the shell, and thereby also to gain access to the beverage containers located on the dispensing track inside the shell, in use. Thus, the door would allow for beverage containers to be dispensed from the dispensing device, and directly from the dispensing track, through the dispensing door, e.g. by manual removal from the dispensing track.

In such an embodiment, the dispensing door may, instead, provide a fixed beverage container locating formation, on or in which a beverage container can in use be located, preferably in a substantially upright configuration, being unloaded onto it from the dispensing track, and from which the beverage container can in use be accessed through the door, to be dispensed from the dispensing device, and more specifically from the locating formation, through the door, e.g. by manual removal from the locating formation.

It would therefore be appreciated that when the dispensing device includes a dispensing door providing a fixed beverage container locating formation, beverage containers would, in use, be collected, and thus dispensed, from the fixed beverage container locating formation, not from the dispensing track. As such, the dispensing device may be configured such that beverage containers would be unloaded from the dispensing track onto/into the fixed beverage container locating formation, for collection from it. It would be appreciated that this would require the unloading end of the dispensing track to be in communication with the beverage container locating formation, for such unloading to occur, preferably under the force of gravity due to movement of beverage containers along the dispensing track.

The fixed beverage container locating formation may therefore be located to receive, and thus be loaded with, a beverage container unloaded from the dispensing track at the unloading end of the dispensing track, due to movement of beverage containers along the dispensing track, typically under the force of gravity.

Typically, in this regard, and as also noted above, the dispensing door may be located such that the fixed beverage container locating formation is located laterally next to the unloading end of the dispensing track, for lateral unloading of the beverage container from the dispensing track onto/into the beverage container locating formation.

It may, however, be that the dispensing door is located such that the fixed beverage container locating formation is located beneath the unloading end of the dispensing track, for vertical unloading of the beverage container from the dispensing track onto/into the beverage container locating formation, e.g. through an opening in the end of the dispensing track, in the manner hereinbefore described.

In another, more preferred embodiment, the dispensing door may provide a movable, i.e. non-fixed, beverage container locating formation, on/in which a beverage container can in use be located in a substantially upright orientation. The movable beverage container locating formation may be movable as part of the dispensing door, i.e. such that movement of the beverage container locating formation is effected by movement of the dispensing door.

Similarly to the embodiment in which the beverage container locating formation is fixed, the dispensing door may in this more preferred embodiment be located such that, at least in the closed configuration described below, the movable beverage container dispensing formation is located to receive, and thus be loaded with, a beverage container unloaded from the dispensing track at the unloading end of the dispensing track, due to movement of beverage containers along the dispensing track, typically under the force of gravity. However, as has been noted above, the beverage container locating formation would, in this more preferred embodiment, be movable, not fixed.

In this regard, also similarly to the embodiment in which the beverage container locating formation is fixed, the dispensing door may be located such that the movable beverage container locating formation is located laterally next to the unloading end of the dispensing track, for lateral unloading of the beverage container from the dispensing track onto/into the movable beverage container locating formation. It may, however, instead be that the dispensing door is located such that the movable beverage container locating formation is located beneath the unloading end of the dispensing track, for vertical unloading of the beverage container from the dispensing track onto/into the movable beverage container locating formation, e.g. through an opening in the end of the dispensing track, in the manner hereinbefore described.

In this embodiment, i.e. when the beverage container locating formation is movable, the dispensing door may be movable between
a closed configuration, in which the beverage container locating formation is located inside of the hollow interior of the shell, thus preventing access, from outside of the hollow interior of the shell, to a beverage container located on the beverage container locating formation in use; and
a dispensing configuration, in which the beverage container locating formation is located outside of the hollow interior of the shell, thus allowing access, from outside of the hollow interior of the shell, to a beverage container located on the beverage container locating formation in use.

The dispensing door, and its mounting in the shell, may be configured such that, in both the closed configuration and the dispensing configuration, the beverage containers remaining on the dispensing track are accessible through the door. In other words, the door may be configured such that, in conventional use, beverage containers located on the dispensing track would be accessible to a consumer through operation of the door. Thus, there would be no separation between a beverage container located on the locating formation and the beverage containers remaining on the dispensing track in either the closed or in the dispensing configurations.

More preferably, the dispensing door may, in the embodiment in which the beverage container locating formation is movable, be configured such that, at least in the dispensing configuration, the dispensing door separates the beverage container locating formation, and therefore a beverage container that is located on it in use, from the hollow interior of the shell. In this respect, the dispensing door may include a separation formation, effecting such separation.

It would be appreciated that, thus, access to beverage containers remaining on the dispensing track would be obstructed in the dispensing configuration of the door, by the separation that is thus effected. Thus, only one beverage container, or at least a desired discrete amount of beverage containers, is dispensed from the device at a time, and access to other beverage containers remaining on the dispensing track is prevented.

The dispensing door, typically by the separation formation, may also be configured such that separation between the locating formation and the exterior of the shell is effected in the closed configuration of the dispensing door, i.e. such that the dispensing door obstructs, typically by the separation formation, access to the locating formation, and thus a beverage container that is in use located on it, from outside of the shell. Thus, access to the locating formation, and therefore to a beverage container that is in use located on it, would be possible only by moving the dispensing door from the closed configuration into the dispensing configuration.

Preferably, the separation effected between the interior of the shell and its surrounds by the dispensing door, and more specifically by the separation formation, when the dispensing door is in its dispensing configuration, is such that there is virtually no air flow, and limited air communication, between the hollow interior of the shell and surrounds of the shell. This may be achieved by including sealing members in the dispensing device, that cover openings between the dispensing door and the shell, through which openings air flow and air communication between the hollow interior of the shell and surrounds of the shell would otherwise have occurred.

The dispensing device may also include sealing members that prevent, virtually fully, air flow, and limits air communication, between the hollow interior of the shell and surrounds of the shell when the dispensing door is in the closed configuration. Thus, the sealing members also prevent passage of cold air inside the interior of the shell, to outside of the shell. The sealing members would typically be fixed either by adhesive or snug fit inside grooves provided therefor in the door, and typically can be made for high quality, long lasting and durable rubber or other suitable sealing material.

In another embodiment, in which the dispensing device is used for heating, the sealing members would serve to prevent passage of hot air inside the interior of the shell, to the outside of the shell.

Due to the stack effect, which is the movement of air into and out of containers due to buoyancy which occurs due to a difference in indoor-to-outdoor air density resulting from temperature and moisture differences, either a positive or negative resulting buoyancy force means that the sealing members will be pushed either inwards/outwards against the walls of the dispensing door and/or dispensing door frame and thus help create an effective sealing of air flow between the inside and outside of the dispensing device. Increased effectiveness of this air sealing aspect may include the use of dispensing door magnets on the edges of the door dispensing mechanism in order to ensure full closure in the closed configuration.

At least some of the walls of the dispensing door may be of polycarbonate material.

The dispensing door may, in order to restrict heat transfer through the door, have spaces defined therein that are vacuum. For example, the door may be double walled, defining spaces between its walls, which spaces are vacuum spaces.

The dispensing door may be mounted for hinged movement, e.g. in the manner in which a conventional door moves, where it extends from a hinge by which it is mounted to a support structure.

Alternatively, and more preferably, the dispensing door may be mounted for rotating movement, e.g. to rotate about an axis about which the door extends in more than one direction. Preferably, the axis would be a vertical, or upright, axis, at least in use.

The dispensing device may be configured for manual or automatic movement of the dispensing door.

For automatic movement of the door, the dispensing device may include an electronic dispensing door controller. The electronic dispensing door controller may be configured selectively to allow and disallow and, optionally, cause movement of the dispensing door from the closed configuration into the dispensing configuration.

When configured selectively to allow and disallow movement of the dispensing door, the electronic dispensing door controller may include locking means operable selectively to lock the dispensing door to disallow movement, and to unlock the dispensing door to allow movement.

When configured also to cause movement of the dispensing door, the electronic dispensing door controller may include a motor, e.g. a servo motor, operable to cause such movement. It would be appreciated that such a motor may also be operable to prevent such movement, and thus provide the locking means, in one embodiment of the invention.

The electronic dispensing door controller may be configured to require direct or indirect electronic communication of an electronic payment signal, indicating that payment has been made for one or more beverage containers to be dispensed, i.e. to allow and, optionally, cause movement of the dispensing door from the closed configuration into the dispensing configuration.

In this regard, the dispensing device may include an electronic communication device that is in electronic wire and/or wireless communication with the electronic dispensing door controller. The electronic communication device may be operable electronically to communicate an electronic payment signal to the electronic dispensing door controller. In use, the electronic payment signal may have been communicated to the electronic communication device by another device, such as an electronic information processing device, such as a computer, or a mobile electronic device, such as a cell phone, by means of which payment was made for one or more beverage containers to be dispensed from the dispensing device.

Preferably, the dispensing device therefore does not include means requiring physical payment to obtain a beverage from it via the dispensing member, i.e. using payment means physically interfacing with the dispensing device to effect payment, such as a cash or physical token deposit, a credit card swipe, or the like. The invention does not absolutely exclude such means from its scope, but it is preferred that the device does not include such means. Typically, and preferably in fact, the device includes means, as described above, for effecting non-physical payment, e.g. electronic, payment, over a wired or wireless electronic communication network.

It would be appreciated that, as such, the dispensing device may be described as a vending machine, albeit an unconventional vending machine in a sense that an option for physical payment is ideally not provided.

As an alternative to, or in addition to, the electronic payment signal-based payment feature, the dispensing device may include an electronic button, mounted on the shell for example, that, when pressed, causes the electronic dispensing door controller to open the dispensing door.

Such a function of the electronic button may also be subject to a payment signal having been received by the dispensing device and, optionally, subject to identification of a consumer as being associated with a particular payment signal.

As alluded to above, the dispensing device may further include a cooling device that is located and is operable to cool, or keep cool, the hollow interior of the shell. Thus, the cooling device would also cool, or keep cool, beverage containers that are in use located on the dispensing track, and the beverages contained by such beverage containers. Alternatively, the dispensing device may include a heating device that is located and operable to heat, or keep heated, the hollow interior of the shell. Thus, the heating device would also heat, or keep heated, beverage containers that are in use located on the dispensing track, and the beverages contained by such beverage containers.

It would be appreciated that conditions that are regarded as “cooled” and “heated” respectively, would be determined as such relative to a reference temperature, which may, for example, be the ambient temperature outside of the shell or a predetermined desired set point temperature.

The cooling/heating device is hereinafter referenced by the term “temperature control device”, which term may be replaced with the term “cooling device” or the term “heating device”, whichever is relevant in the context. It is, in fact, preferred for the temperature control device to have both heating and cooling functionality, so that heating/cooling can selectively be effected.

The temperature control device may, for example, be a compressor or a thermoelectric device such as a so-called Peltier device. Preferably, the temperature control device is a Peltier device.

The temperature control device may be located in any functionally effective location in the dispensing device. Typically, the temperature control device would be located in an operative base of the shell, below the dispensing track.

Preferably, the temperature control device is located such that it is functionally directed into the hollow interior and immediate surrounds of the support structure of the dispensing track. More specifically, a cold side/hot side, as the case may be, of the temperature control device may be directed into the hollow interior and immediate surrounds of the support structure.

Preferably, the cold side/hot side, as the case may be, is attached to a base of the support structure using:

a homogeneously welded or otherwise attached metal block to provide efficient heat transfer from the temperature control device to the support structure;

a clamp with bolts to provide effective pressure and contact between the support structure and the temperature control device; and/or insulation material to prevent any heat transfer between the inside of the shell and the base area where the temperature control device is usually situated.

In the latter respect, it would be appreciated that, ideally, the shell would define a major interior, in which the dispensing track would be located, and a minor interior, in which ancillary components like the temperature control device and its heat sink and metal block, if used, would be located.

Thus, the cooling/heating functionality of the temperature control device, i.e. cooling/heating of air inside the interior of the shell, would be concentrated in the hollow interior and immediate surrounds of the support structure, from which it would be distributed to the remainder of the interior of the shell through the apertures in the support structure. This is regarded as one of the advantages of the invention, in that an evenly distributed temperature control effect is thus obtained throughout the device, avoiding having a concentrated temperature-controlled area existing near the temperature control device and the remainder of the interior of the shell being neglected. More specifically, temperature control is thus concentrated in a volume that extends along the length of the dispensing track, rather than at the unloading end of the dispensing track, thus allowing for a more even distribution of the effect throughout the interior of the shell.

Another advantage of the invention, is that due to the support structure serving the dual function of both supporting the dispensing track and acting as a cooling/heating element, no additional cold/hot sink is required to be placed on the inside of the shell as would be the case in traditional thermoelectric cooling/heating devices. In other words, the support structure acts as the cold/hot sink, and becomes cold/hot, as the case may be. This dual function of the support structure further allows for space saving within the shell of the dispenser, further enabling a smaller external footprint of the device. Having a smaller and minimal footprint is another major advantage of the invention, since space on and behind counter tops in retail stores, bars, restaurants and homes is usually a major concern and highly competitive between competing beverage and other brands.

The dispensing device may also include a beverage container loading zone, at which beverage containers are loaded onto the dispensing track in use. Typically, the loading zone would be at or near an operative top of the dispensing track, at or near the loading end of the dispensing track.

When the device includes a shell as hereinbefore described, the loading zone may be provided by a loading port that is defined in an operative top of the shell. It will be appreciated that the dispensing device would thus provide a “top-loading” configuration.

The loading zone may be configured, as a top loading zone, for delivery of beverage containers to the device by means of an unmanned aerial vehicle (UAV), also known more commonly as a drone. In this case, a quadcopter-type drone is envisaged. Thus, the device, and more particularly the shell, may have formations that can receive a drone, or more specifically a delivery formation of a drone, that is configured to carry and dispense, into the shell and onto the dispensing track, beverage containers carried by the drone.

The dispensing device may further include one or more of
a dispensing door status sensor that is capable of sensing, in use, whether the dispensing member is in a condition that allows access to a beverage received by it, or not;
a proximity sensor that is capable of
   sensing whether the dispensing device is too close to any obstruction, object or person that may or may not be in nearby proximity to the device, and/or
   measuring the device's relative co-ordinates and/or position as compared to its original position before being required to dispense, refill with stock or examine by the intermediary vendor or end-user (this would be beneficial when utilizing the device with any space saving add-ons such as an extendable/retractable arm or displaceable cable attached to the device, capable of moving the device, e.g. between a stored and a dispensing position);
a camera inside and/or a camera outside of the shell, capable of transmitting, to a receiving device and, optionally, a video/photo display device and, optionally, a video/photo storage device, video or photo images from inside and/or outside of the shell;
a speaker, typically one to which a music playing device could connect with a Bluetooth™ interface, or a wi-fi interface, or a physical wire interface;
a global positioning system (GPS) device that allows for the position of the device to be determined, preferably to a level of accuracy within a centimetre or two;
a sensor capable of detecting icing at/near the bottom of the device and of directing adjustment of the temperature of the device, to cause defrosting, the resulting water of which may be channelled to the heat sink to cause evaporation thereof and assist in cooling, with the device being configured accordingly;
one or more USB and/or HDMI port to allow charging of mobile devices, e.g. phones or tablets, or to communicate with the electronic communication device and/or the electronic information processing device and/or the electronic information reporting device; and
a biometric interface device, such as a fingerprint reader, that validates the identity of a user for functional purposes, e.g. operation of the door.

The dispensing device may further include one or more sensor/s that detect desired information relating to the dispensing device and its surrounds.

At least, the dispensing device may include an electronic stock sensor. The electronic stock sensor may be capable of detecting and/or monitoring the number of beverage containers that are located on the dispensing track of the dispensing device, and of electronically communicating an electronic information signal containing information of the number of beverage containers that are located on the dispensing track of the dispensing device.

In this sense, the term “number of beverage containers” must not be limited to a narrow interpretation of an exact number, although it includes such an interpretation. More broadly, however, the term should be understood as meaning that the electronic stock sensor is capable of monitoring and electronically communicating an electronic information signal containing information quantifying the stock, i.e. beverage containers, in the dispensing device, e.g. to the effect that that the level of stock has reached a predetermined point with reference to the absence of beverage containers in a particular section of the dispensing track, and/or the location of the last (i.e. furthest from the unloading end) beverage container in a series arrangement of beverage containers on the dispensing track, and/or the weight of the loading on the dispensing track, and the like.

Thus, the electronic stock sensor may be arranged and configured to detect and/or monitor the loading of the dispensing track with beverage containers (i.e. its stock quantity), e.g. with reference to the number of beverage containers located on the dispensing track at any time and/or at a particular time, and/or that the number of beverage containers located on the dispensing track has reached and/or is below a predetermined level/number. This important functionality allows for the refilling of the unit by an operator, e.g. an intermediary user such as a barman or store manager, or an end user such as a home owner, thus ensuring enough time for the newly inserted beverage cans/containers to either cool down/heat up to the desired best served temperature.

The dispensing device may also include one or more electronic operating condition sensor/s, capable of monitoring and electronically communicating one or more electronic information signals containing information of operating conditions of the dispensing device.

Operating conditions that would be monitored would typically be selected from one or a combination of any two or more of
the temperature inside of the hollow interior of the shell,
the temperature outside of the hollow interior of the shell,
the power usage of the dispensing device, and
the humidity inside of the hollow interior of the shell.

In respect of the power usage of the dispensing device, power usage at a particular point in time, total power usage over a period of time, power usage profile over a period of time, and average power usage over a period of time, are included.

The sensor/s may be configured to provide and communicate electronic information signals, including a stock information signal and, optionally, one or more operating condition information signals, containing information including stock information and, optionally, operating condition information detected by the sensor/s.

The dispensing device may further include at least one electronic communication device that is in electronic wire and/or wireless communication with one or more of the sensor/s. The electronic communication device may be configured to receive electronic information signals communicated by the sensor/s and may be capable of electronically communicating information contained in the electronic information signals received from the sensor/s. Such electronic communication may be in fresh electronic information signals, to other devices. Such other devices may include an electronic information processing device and/or an electronic information reporting device as described below with reference to the current aspect of the invention and/or with reference to the second aspect of the invention.

The electronic communication device may be an electronic communication device as described above, with reference to the electronic dispensing door controller.

The dispensing device may also include at least one electronic information processing device that is in electronic wire and/or wireless communication with the at least one communication device, to receive electronic information signals communicated by the at least one communication device.

The electronic information processing device can be of such scalability and nature, that it can be tested, programmed or have its software upgraded either remotely via the remote cloud or supplier computer, or directly via plugging in through USB/HDMI/Bluetooth/WiFi or other communicative ports, whichever is applicable as the case may be in the model version in use. This applies to all electronic information processing devices described according to the invention.

The electronic information processing device may be capable of electronically processing information contained in the electronic information signals received from the communication device. In this sense, “processing” includes both storing the information contained in the electronic information signals received from the electronic communication device and creating new information using the information contained in the electronic information signals received from the communication device.

Typically, the electronic information processing device would be a computer processor.

The dispensing device may further include at least one electronic information reporting device that is in electronic wire and/or wireless communication with the at least one electronic information processing device and, optionally, with the at least one communication device, to receive electronic information signals communicated by the at least one information processing device and, optionally, by the at least one communication device.

The electronic information reporting device may be capable of visually reporting, i.e. displaying, information contained in the electronic information signals received from the at least one information processing device and, optionally, from the at least one communication device, or information based on information contained in the electronic information signals received from the at least one information processing device and, optionally, from the at least one communication device.

As such, the electronic information reporting device may include an electronic screen on which such information can be visually reported, i.e. displayed.

Further features of the electronic communication device, the electronic information processing device, and the electronic information reporting device may be as described in accordance with the system of the third aspect of the invention. In fact, in the embodiment of the system of the third aspect of the invention in which the dispensing device includes the electronic communication device and the electronic information processing device and the electronic information reporting device, the system of the third aspect of the invention may provide the dispensing device of the current, first, aspect of the invention. This applies equally to the fourth aspect of the invention.

In one embodiment of the invention, the dispensing device of the current, first, aspect of the invention, may be a dispensing device according to the fourth aspect of the invention. It would be appreciated that, in such an embodiment, the dispensing device would include the dispensing door as required by the fourth aspect of the invention, which may be the dispensing door as described above.

THE INVENTION EXTENDS, AS A SEPARATE ASPECT THEREOF, to the dispensing device of the first aspect of the invention, in use, in which a plurality of beverage containers, preferably cans, are located on and along the dispensing track in series, in the manner described according to the first aspect of the invention, in use.

THE INVENTION ALSO EXTENDS, AS A SEPARATE ASPECT THEREOF, to a method of operating the dispensing device of the first aspect of the invention, as characterised in respect of the first aspect of the invention, in use.

IN ACCORDANCE WITH A SECOND ASPECT OF THE INVENTION IS PROVIDED a method of dispensing a beverage container, containing a beverage, from a dispensing device according to the first or fourth aspects of the invention, which device contains a plurality of beverage containers containing a beverage, the method including
locating one, or more, of the beverage containers, or another beverage container, on the beverage container locating formation of the dispensing door of the dispensing device in the closed configuration of the dispensing door; and
moving the dispensing door from the closed configuration into the dispensing configuration.

The method may also include a prior step of locating a plurality of beverage containers containing a beverage, in series, on the dispensing track of the dispensing device;

Typically, only one beverage container would be located on the locating formation at a time.

The method may also include, after collection of the beverage container located on the locating formation, moving the dispensing door from the dispensing configuration into the closed configuration, thereby allowing or causing the beverage container locating formation to receive, and thus be loaded with, a fresh beverage container from the dispensing track, due to movement of beverage containers along the dispensing track.

Hereinafter, in respect of the present aspect of the invention, where a feature is described that it may be a feature of the first or fourth aspects of the invention, specifically with reference to the electronic communication device, the electronic information processing device and the electronic information reporting device, it means that one or more of these devices may be included in the dispensing device of the first or fourth aspects of the invention, as described in accordance with those aspects respectively. This does not exclude, however, that, for the purpose of the method, one or more of these devices may be provided separately of the dispensing device of the first or fourth aspects of the invention.

The method may include electronically communicating one or more electronic information signals from the sensor/s of the dispensing device of the first or fourth aspects of the invention, to an electronic communication device, which may be an electronic communication device of the dispensing device of the first or fourth aspects of the invention or an electronic communication device of a system according to the third aspect of the invention.

The method may further include, by means of the electronic communication device, electronically communicating, in one or more electronic information signals, information contained in the electronic information signals received by the electronic communication device from the sensor/s, to an electronic information processing device, which may be an electronic information processing device of the dispensing device according to the first or fourth aspects of the invention or an electronic communication device of a system according to the third aspect of the invention.

The method may also include, by means of the electronic information processing device and, optionally, the electronic communication device, one or both being of the dispensing device according to the first or fourth aspects of the invention or one or both being of a system according to the third aspect of the invention, electronically communicating, in one or more electronic information signals,
information contained in one or more electronic information signals received by the electronic information processing device from the electronic communication device; and/or
information based on information contained in one or more electronic information signals received by the electronic information processing device from the electronic communication device; and/or
information contained in one or more electronic information signals communicated by the electronic communication device,
   to an electronic information reporting device, which may be an electronic information reporting device of the dispensing device according to the first or fourth aspects of the invention or an electronic communication device of a system according to the third aspect of the invention.

Still further, the method may include, by means of the electronic information reporting device, visually displaying
information contained in one or more electronic information signals received by the electronic information reporting device from the electronic information processing device and, optionally, the electronic communication device, and/or
information based on information contained in one or more electronic information signals received by the electronic information reporting device from the electronic information processing device and, optionally, from the electronic communication device.

The method may further include communicating, directly or indirectly, an electronic payment signal to the electronic dispensing door controller of the dispensing device according to the first or fourth aspects of the invention to allow and, optionally, cause the dispensing door to be moved from the closed configuration into the dispensing configuration, by the dispensing door controller.

The method may also include automatically, i.e. without human intervention, placing, by means of the electronic information processing device, an order for new stock, i.e. beverage containers containing beverage, if the stock level in the dispensing device is detected to have fallen below a predetermined level. Placing such an order may involve electronically communicating, in an electronic information signal, directly or indirectly, a requirement for new stock to a holder of stock, e.g. a representative of a supplier of the beverage containers containing beverage.

The communicated requirement may in some embodiments not be an outright order, but rather a notification of stock level being below a predetermined level, that prompts the supplier to dispatch a representative to the location of the dispensing device. Placing of an order may in some embodiments require manual input, without excluding the automatic ordering option.

Similarly, the method may include informing, by means of the electronic information reporting device, a user and/or observer and/or operator and/or third party, of the dispensing device that the stock level in the dispensing device has fallen below a predetermined level, e.g. as an alert to the user and/or observer and/or operator to replenish the stock in the dispensing device.

In an embodiment in which re-stocking of the device is effected by means of a drone, as herein described, communication of the electronic information signal regarding stock levels may automatically cause collection, by the drone, of stock, and subsequent delivery thereof to the device. Thus, the electronic information signal regarding stock levels may be communicated, directly or indirectly, to a device or person operating the drone, in order to cause such an effect. In this regard the system of the invention may be configured accordingly, and the method of the invention may include such a communication step.

It would be appreciated that the same would apply for operating conditions that are monitored by means of the sensors of the dispensing device, i.e. that a user and/or observer and/or operator of the dispensing device may be alerted to the current condition, or the existence of an undesired condition, in the dispensing device.

Insofar the electronic communication device and/or the electronic information processing device and/or the electronic information reporting device are not included in the dispensing device, the method of this, second, aspect of the invention may be a method of operating a beverage container storage and dispensing system, as described in accordance with the following, third aspect of the invention.

IN ACCORDANCE WITH A THIRD ASPECT OF THE INVENTION IS PROVIDED a beverage container storage and dispensing system, comprising
a dispensing device according to the first or fourth aspects of the invention, the system further including
an electronic communication device that is in electronic wire and/or wireless communication with one or more of the sensor/s of the dispensing device, to receive electronic information signals electronically communicated by the sensor/s, the electronic communication device being capable of electronically communicating, in electronic information signals, information contained in electronic information signals received by the electronic communication device from the sensor/s;
an electronic information processing device that is in electronic wire and/or wireless communication with the electronic communication device, to receive electronic information signals electronically communicated by the electronic communication device, the electronic information processing device being capable of
   electronically processing information contained in electronic information signals received from the electronic communication device, and
   electronically communicating, in electronic information signals,
      information contained in electronic information signals received from the electronic communication device, and/or
      information based on information contained in electronic information signals received from the electronic communication device; and
an electronic information reporting device that is in electronic wire and/or wireless communication with the electronic information processing device and, optionally, with the electronic communication device, to receive electronic information signals communicated by the electronic information processing device and, optionally, by the electronic communication device, the electronic information reporting device being capable of visually reporting
   information contained in electronic information signals received from the electronic information processing device, and/or
   optionally, information contained in electronic information signals received from the electronic communication device, and/or
   information based on information contained in electronic information signals received from the electronic information processing device, and/or
   optionally, information based on information contained in electronic information signals received from the electronic communication device.

It must be noted that although components of the system are characterised in singular form, a plurality thereof may be included in some embodiments. For example, the system may include a plurality of dispensing devices, each having its own sensors and electronic communication device, each of which is in communication with a single electronic information processing device, which is, in turn, in communication with various electronic information reporting devices.

The electronic communication device, the electronic information processing device, and the electronic information reporting device may be as described in accordance with the first aspect of the invention, with the proviso that inclusion thereof in the dispensing device is not required. In other words, one or more, or all, of the electronic communication device, the electronic information processing device, and the electronic information reporting device may be included in the dispensing device, and/or one or more, or all, of the electronic communication device, the electronic information processing device, and the electronic information reporting device may exist separately of the dispensing device.

Thus, electronic communication device and/or the electronic information processing device and/or and the electronic information reporting device may be included in the dispensing device, in accordance with the first aspect of the invention. Alternatively, one or more, or all, of these may be provided separately of the dispensing device.

When the system includes a plurality of dispensing devices and a plurality of any one or more of the electronic communication device and/or the electronic information processing device and/or and the electronic information reporting device, some of the electronic communication devices and/or the electronic information processing devices and/or and the electronic information reporting devices may be included in some of the dispensing devices, while some may be provided separately thereof.

The system may be a system for performing the method of the invention, according to the second aspect of the invention, as described above.

The electronic communication device may be integral with the sensors. Thus, each sensor may have its own electronic communication device. Alternatively, the electronic communication device may be separate of the sensors.

In one embodiment of the invention the system may include at least one electronic information processing device that is included in at least one dispensing device.

In another embodiment of the invention the system may include, in addition or alternatively to the at least one information processing device that is included in the dispensing device, at least one information processing device that is provided separately, and more typically remotely of at least one dispensing device.

The information processing device may be a computer.

The computer may for example be a remote server that is hosted on the internet, with communication between the electronic communication device and the electronic information processing device thus being over the internet, and with these devices thus being configured accordingly. This practice would be understood by those skilled in the art as being broadly known as “cloud computing”.

The electronic information processing device may be configured to process, electronically, information communicated to it by the electronic communication device, e.g. by calculating an average of the power usage of the dispensing device over a period of time, by rendering information communicated to it by the electronic communication device in a reportable format, or the like. Thus, the electronic information processing device may generate information based on information contained in the electronic information signals communicated to it by the electronic communication device.

The electronic information processing device may be configured to store electronically, in memory, information contained in the electronic information signals communicated to it by the electronic communication device and/or information based on information contained in the electronic information signals communicated to it by the electronic communication device.

Electronic communication between the electronic information reporting device, on the one hand, and, on the other hand, the electronic information processing device and, optionally, the electronic communication device, may be configured such that the electronic information reporting device either retrieves information from the electronic information processing device and electronic communication device, or receives information therefrom. The electronic information reporting device may be configured accordingly.

Thus, in one embodiment of the invention, information is actively communicated to the electronic information reporting device, without the electronic information reporting device needing to request information, and in another embodiment of the invention information is requested by the electronic information reporting device. Combinations are also envisaged. For example, some types of information may be communicated to the electronic information reporting device without a request from the information reporting device, while other types of information may be communicated to the electronic information reporting device upon request to the electronic information reporting device.

It would be appreciated that the electronic information reporting devices may therefore report information received, and/or information based on information received, from the electronic communication device. Further, the electronic information reporting device may report information received, and/or information based on information received, from the electronic information processing device. As noted above, information received may either be information retrieved in response to a request from the electronic information reporting device, or not in response to such a request, i.e. being automatically communicated.

As noted earlier, the electronic information reporting device may be included in the dispensing device. In addition, or alternatively, the, or another, electronic information reporting device may be separate and, more typically, remote of the dispensing device.

The electronic information reporting device would typically comprise a screen on which information can be visually reported. For example, the electronic information reporting device may be a wireless device, e.g. a mobile device such as a cellular telephone or tablet, and/or a computer. Such an electronic information reporting device would typically comprise reporting software, i.e. a reporting computer program, that would report information received by the electronic information reporting device.

Typically, electronic communication between the electronic information reporting device and the electronic communication device and/or the electronic information processing device would be electronic communication over the internet. The devices may therefore be configured accordingly.

The electronic information processing device may be configured automatically, i.e. without human intervention, to place an order for new stock, i.e. beverage containers containing beverage, if the stock level in the dispensing device is detected to have fallen below a predetermined level. Placing such an order may involve communicating a requirement for new stock with a holder of stock, e.g. a representative of a supplier of the beverage containers containing beverage. The communicated requirement may in some embodiments not be an outright order, but rather a notification of stock level being below a predetermined level, that prompts the supplier to dispatch a representative to the location of the dispensing device that forms part of the system. Placing of an order may in some embodiments require manual input, without excluding the automatic ordering option.

Similarly, the electronic information reporting device may be configured to inform a user and/or observer and/or operator of the dispensing device that the stock level in the dispensing device has fallen below a predetermined level, as an alert to the user and/or observer and/or operator to replenish the stock in the dispensing device.

It would be appreciated that the same would apply for operating conditions that are monitored by means of the sensors of the dispensing device, i.e. that a user and/or observer and/or operator of the dispensing device may be alerted to the current condition, or the existence of an undesired condition, in the dispensing device.

The system may include a UAV as hereinbefore described.

IN ACCORDANCE WITH A FOURTH ASPECT OF THE INVENTION IS PROVIDED a beverage container storage and dispensing device (“dispensing device”) that comprises
a hollow shell defining a hollow interior;
a beverage container storage and dispensing track (“dispensing track”) located inside the hollow interior of the shell; and
a dispensing door located in a dispensing opening in the shell and providing a beverage container locating formation, onto which a beverage container can, in use, be unloaded from the dispensing track, thus being located on the beverage container locating formation, inside of the hollow interior of the shell,
   wherein the dispensing door is movable between
a closed configuration, in which the beverage container locating formation is located inside of the hollow interior of the shell, thus preventing access, from outside of the shell, to a beverage container located on the beverage container locating formation in use; and
a dispensing configuration, in which the beverage container locating formation is located outside of the hollow interior of the shell, thus allowing access, from outside of the shell, to a beverage container located on the beverage container locating formation in use.

The shell may be a shell as described according to the first aspect of the invention, with the configuration of the dispensing track according to the first aspect of the invention being optional, although it is preferred, for the purpose of the present, fourth, aspect of the invention.

More specifically, the shell would typically be cylindrical, with a closed top and bottom. As such, the shell may have a cylindrical sidewall.

The shell may provide for the device to carry an ornamental or informative representation, such as branding, typically on a wrap-around member, such as a film or sleeve of polymeric material. When the shell is cylindrical, as described above, the cylindrical sidewall would typically be slightly inwardly offset from a rim of the top and bottom, thereby to provide a cavity complemental to a wrap-around sleeve that may be mounted to the sidewall in use, for display ornamental or informative features.

The shell may have any desired shape and configuration, provided that it is shaped and configured such that it can accommodate the dispensing track therein. It follows that the height and diameter of the shell would be selected with reference to the size of the dispensing track, and further with reference to other practical considerations, such as handling and space requirements. In one embodiment of the invention, the diameter of the shell may be up to 50 cm, typically up to 40 cm, e.g. 30 cm, and the height of the shell may be up to 1.5 m, typically up to 1 m, e.g. 90 cm. In other embodiments, the diameter can be larger than 50 cm. It is expected that the diameter would ultimately be dictated by an operator/owner of the device, with reference to the abovementioned practical considerations.

Preferably, the shell would be shaped in the likeness of a beverage container, e.g. a bottle or a can. As shown in the exemplary embodiment of the invention discussed with reference to the drawings later on, the shell is preferably shaped in the likeness of a can.

As noted above, dispensing track would be located inside of the hollow interior of the shell. Thus, the dispensing track would be isolated, by the shell, from surrounds of the shell, and access to beverage containers located on, and along, the dispensing track, in use, would be restricted, in the case of the present aspect of the invention being allowed only through the door, for the purpose of dispensing at least.

The shell may be insulated, specifically thermally insulated, to assist in maintaining a desired temperature in its interior. In this regard, the shell may include a thermal insulation layer in a wall thereof. Typically, when the shell includes a thermal insulation layer and is cylindrical, the layer would at least be provided in the sidewall of the shell.

The thickness of the thermal insulation layer may be selected depending on required efficacy and practical considerations, e.g. manufacturing considerations, ease of handling, and considerations relating to the location of installation, store space availability and/or use of the dispensing device. For example, the thermal insulation layer may have a thickness of up to 10 cm, more typically up to 5 cm.

The thermal insulation layer may be of a thermally insulating material, e.g. polyurethane.

Alternatively, the thermal insulation layer may also be configured as a vacuum formed wall, e.g. similar to the configuration of a thermos flask.

The dispensing track may be a helical beverage container storage and dispensing track as described in accordance with the first aspect of the invention, including that the dispensing track may include additional dispensing tracks as described in accordance with the first aspect of the invention and including that it may be integrally formed or assembled as described above according to the first aspect of the invention.

As such, the dispensing device may also include a support structure for the dispensing track, as described according to the first aspect of the invention. All of the features of the dispensing track, additional dispensing track, and support structure described according to the first aspect of the invention may therefore, jointly or severally, apply to the dispensing track, additional dispensing track, and support structure of the dispensing device of the current, fourth, aspect of the invention, including their “in use” features which would then apply equally to the current aspect of the invention. In this regard is included the manner of loading and unloading of beverage containers from the dispensing track onto the locating formation of the dispensing door, the manner of movement of beverage containers between additional dispensing tracks and between the dispensing tracks and additional dispensing tracks, and the manner of movement of beverage containers along the dispensing track and additional dispensing tracks.

In respect of the locating formation, it would be appreciated that since the door is movable between the closed and dispensing configurations, the locating formation is a movable locating formation, not a fixed locating formation as described as one embodiment according to the first aspect of the invention.

Furthermore, the dispensing door may also be a dispensing door as described according to the first aspect of the invention, with the configuration of the dispensing track according to the first aspect of the invention being optional, although it is preferred, for the purposes of the present aspect of the invention.

More specifically, the dispensing door may be located such that, in the closed configuration, the beverage container dispensing formation is located to receive, and thus be loaded with, a beverage container unloaded from the dispensing track at an unloading end of the dispensing track. In use, such unloading would typically be due to movement of beverage containers along the dispensing track, typically under force of gravity, e.g. as described also according to the first aspect of the invention.

In this regard, the dispensing door may be located such that the beverage container locating formation is located laterally next to the unloading end of the dispensing track, for lateral unloading of the beverage container from the dispensing track onto/into the beverage container locating formation. It may, however, instead be that the dispensing door is located such that the beverage container locating formation is located beneath the unloading end of the dispensing track, for vertical unloading of the beverage container from the dispensing track onto/into the beverage container locating formation, e.g. through an opening in the end of the dispensing track, e.g. as described according to the first aspect of the invention.

The dispensing door may be configured such that, at least in the dispensing configuration, the dispensing door separates the beverage container locating formation, and therefore a beverage container that is located on it in use, from the hollow interior of the shell. In this respect, the dispensing door may include a separation formation, effecting such separation.

It would be appreciated that, thus, access to beverage containers remaining on the dispensing track would be obstructed in the dispensing configuration of the door, by the separation that is thus effected. Thus, only one beverage container, or at least a desired discrete amount of beverage containers, is dispensed from the device at a time, and access to other beverage containers remaining on the dispensing track is prevented.

The dispensing door, typically by the separation formation, may also be configured such that separation between the locating formation and the exterior of the shell is effected in the closed configuration of the dispensing door, i.e. such that the dispensing door obstructs, typically by the separation formation, access to the locating formation, and thus a beverage container that is in use located on it, from outside of the shell. Thus, access to the locating formation, and therefore to a beverage container that is in use located on it, would be possible only by moving the dispensing door from the closed configuration into the dispensing configuration.

Preferably, the separation effected between the interior of the shell and its surrounds by the dispensing door, and more specifically by the separation formation, when the dispensing door is in its dispensing configuration, is such that there is virtually no air flow, and limited air communication, between the hollow interior of the shell and surrounds of the shell. This may be achieved by including sealing members in the dispensing device, that cover openings between the dispensing door and the shell, through which openings air flow and air communication between the hollow interior of the shell and surrounds of the shell would otherwise have occurred.

The dispensing device may also include sealing members that prevent, virtually fully, air flow, and limits air communication, between the hollow interior of the shell and surrounds of the shell when the dispensing door is in the closed configuration. Thus, the sealing members also prevent passage of cold air inside the interior of the shell, to outside of the shell.

In another embodiment, in which the dispensing device is used for heating, the sealing members also prevent passage of hot air inside the interior of the shell, to the outside of the shell.

The dispensing door may be mounted for hinged movement, e.g. in the manner in which a conventional door moves, where it extends from a hinge by which it is mounted to a support structure.

Alternatively, and more preferably, the dispensing door may be mounted for rotating movement, e.g. to rotate about an axis about which the door extends in more than one direction. Preferably, the axis would be a vertical, or upright, axis, at least in use.

The dispensing device may be configured for manual or automatic movement of the dispensing door.

For automatic movement of the door, the dispensing device may include an electronic dispensing door controller. The electronic dispensing door controller may be configured selectively to allow and disallow and, optionally, cause movement of the dispensing door from the closed configuration into the dispensing configuration.

When configured selectively to allow and disallow movement of the dispensing door, the electronic dispensing door controller may include locking means operable selectively to lock the dispensing door to disallow movement, and to unlock the dispensing door to allow movement.

When configured also to cause movement of the dispensing door, the electronic dispensing door controller may include a motor, e.g. a servo motor, operable to cause such movement. It would be appreciated that such a motor may also be operable to prevent such movement, and thus provide the locking means, in one embodiment of the invention.

The electronic dispensing door controller may be configured to require direct or indirect electronic communication of an electronic payment signal, indicating that payment has been made for one or more beverage containers to be dispensed, i.e. to allow and, optionally, cause movement of the dispensing door from the closed configuration into the dispensing configuration.

In this regard, the dispensing device may include an electronic communication device that is in electronic wire and/or wireless communication with the electronic dispensing door controller. The electronic communication device may be operable electronically to communicate an electronic payment signal to the electronic dispensing door controller. In use, the electronic payment signal may have been communicated to the electronic communication device by another device, such as an electronic information processing device, such as a computer, or a mobile electronic device, such as a cell phone, by means of which payment was made for one or more beverage containers to be dispensed from the dispensing device.

Preferably, the dispensing device therefore does not include means requiring physical payment to obtain a beverage from it via the dispensing member, i.e. using payment means physically interfacing with the dispensing device to effect payment, such as a cash or physical token deposit, a credit card swipe, or the like. The invention does not absolutely exclude such means from its scope, but it is preferred that the device does not include such means. Typically, and preferably in fact, the device includes means, as described above, for effecting non-physical payment, e.g. electronic, payment, over a wired or wireless electronic communication network.

It would be appreciated that, as such, the dispensing device may be described as a vending machine, albeit an unconventional vending machine in a sense that an option for physical payment is ideally not provided.

As an alternative to, or in addition to, the electronic payment signal-based payment feature, the dispensing device may include an electronic button, mounted on the shell for example, that, when pressed, causes the electronic dispensing door controller to open the dispensing door.

Such a function of the electronic button may also be subject to a payment signal having been received by the dispensing device and, optionally, subject to identification of a consumer as being associated with a particular payment signal.

The dispensing device may further include a cooling device that is located and is operable to cool, or keep cool, the hollow interior of the shell, e.g. as described according to the first aspect of the invention, with the configuration of the dispensing track according to the first aspect of the invention being optional, although preferred, for the purposes of the current, fourth, aspect of the invention.

The cooling device would therefore, in use, cool, or keep cool, beverage containers that are in use located on the dispensing track, and the beverages contained by such beverage containers. Alternatively, the dispensing device may include a heating device that is located and operable to heat, or keep heated, the hollow interior of the shell. Thus, the heating device would also heat, or keep heated, beverage containers that are in use located on the dispensing track, and the beverages contained by such beverage containers.

It would be appreciated that conditions that are regarded as “cooled” and “heated” respectively, would be determined as such relative to a reference temperature, which may, for example, be the ambient temperature outside of the shell or a predetermined desired set point temperature.

The cooling/heating device is hereinafter referenced by the term “temperature control device”, which term may be replaced with the term “cooling device” or the term “heating device”, whichever is relevant in the context. It is, in fact, preferred for the temperature control device to have both heating and cooling functionality, so that heating/cooling can selectively be effected.

The temperature control device may, for example, be a compressor or a thermoelectric device such as a so-called Peltier device. Preferably, the temperature control device is a Peltier device.

The temperature control device may be located in any functionally effective location in the dispensing device. Typically, the temperature control device would be located in an operative base of the shell, below the dispensing track.

Preferably, the temperature control device is located such that it is functionally directed into the hollow interior and immediate surrounds of the support structure of the dispensing track. More specifically, a cold side/hot side, as the case may be, of the temperature control device may be directed into the hollow interior and immediate surrounds of the support structure.

Preferably, the cold side/hot side, as the case may be, is attached to the base of the support structure using:

a homogeneously welded or otherwise attached metal block to provide efficient heat transfer from the thermo couple to the support structure;

a clamp with bolts to provide effective pressure and contact between the support structure and the thermo couple; and/or

insulation material to prevent any heat transfer between the inside of the shell and the outside base area where the temperature control device is usually situated.

Thus, the cooling/heating functionality of the temperature control device, i.e. cooling/heating of air inside the interior of the shell, would be concentrated in the hollow interior and immediate surrounds of the support structure, from which it would be distributed to the remainder of the interior of the shell through the apertures in the support structure. This is regarded as one of the advantages of the invention, in that an evenly distributed temperature control effect is thus obtained throughout the device, avoiding having a concentrated temperature-controlled area existing near the temperature control device and the remainder of the interior of the shell being neglected. More specifically, temperature control is thus concentrated in a volume that extends along the length of the dispensing track, rather than at the unloading end of the dispensing track, thus allowing for a more even distribution of the effect throughout the interior of the shell.

The dispensing device may also include a beverage container loading zone, at which beverage containers are loaded onto the dispensing track in use. Typically, the loading zone would be at or near an operative top of the dispensing track, at or near the loading end of the dispensing track.

The loading zone may be provided by a loading port that is defined in an operative top of the shell. It will be appreciated that the dispensing device would thus provide a “top-loading” configuration.

The dispensing device may further include one or more of
a dispensing door status sensor that is capable of sensing, in use, whether the dispensing member is in a condition that allows access to a beverage received by it, or not;
a dispensing door status sensor that is capable of sensing, in use, whether the dispensing member is in a condition that allows access to a beverage received by it, or not;
a proximity sensor that is capable of
   sensing whether the dispensing device is too close to any obstruction, object or person that may or may not be in nearby proximity to the device, and/or
   measuring the device's relative co-ordinates and/or position as compared to its original position before being required to dispense, refill with stock or examine by the intermediary vendor or end-user (this would be beneficial when utilizing the device with any space saving add-ons such as an extendable/retractable arm or displaceable cable attached to the device, capable of moving the device, e.g. between a stored and a dispensing position);
a camera inside and/or a camera outside of the shell, capable of transmitting, to a receiving device and, optionally, a video/photo display device and, optionally, a video/photo storage device, video or photo images from inside and/or outside of the shell;
a speaker, typically one to which a music playing device could connect with a Bluetooth™ interface, or a wi-fi interface, or a physical wire interface;
a global positioning system (GPS) device that allows for the position of the device to be determined, preferably to a level of accuracy within a centimetre or two;
a sensor capable of detecting icing at/near the bottom of the device and of directing adjustment of the temperature of the device, to cause defrosting, the resulting water of which may be channelled to the heat sink to cause evaporation thereof and assist in cooling, with the device being configured accordingly; and
one or more USB and/or HDMI port to allow charging of mobile phones or to communicate with the electronic communication device and/or the electronic information processing device and/or the electronic information reporting device; and
a biometric interface device, such as a fingerprint reader, that validates the identity of a user for functional purposes, e.g. operation of the door.

The dispensing device may further include one or more sensor/s that detect desired information relating to the dispensing device and its surrounds.

At least, the dispensing device may include an electronic stock sensor. The electronic stock sensor may be capable of detecting and/or monitoring the number of beverage containers that are located on the dispensing track of the dispensing device, and of electronically communicating an electronic information signal containing information of the number of beverage containers that are located on the dispensing track of the dispensing device.

In this sense, the term “number of beverage containers” must not be limited to a narrow interpretation of an exact number, although it includes such an interpretation. More broadly, however, the term should be understood as meaning that the electronic stock sensor is capable of monitoring and electronically communicating an electronic information signal containing information quantifying the stock, i.e. beverage containers, in the dispensing device, e.g. to the effect that that the level of stock has reached a predetermined point with reference to the absence of beverage containers in a particular section of the dispensing track, and/or the location of the last (i.e. furthest from the unloading end) beverage container in a series arrangement of beverage containers on the dispensing track, and/or the weight of the loading on the dispensing track, and the like.

Thus, the electronic stock sensor may be arranged and configured to detect and/or monitor the loading of the dispensing track with beverage containers (i.e. its stock quantity), e.g. with reference to the number of beverage containers located on the dispensing track at any time and/or at a particular time, and/or that the number of beverage containers located on the dispensing track has reached and/or is below a predetermined level/number. This important functionality allows for the refilling of the unit by an operator, e.g. an intermediary user such as a barman or store manager, or an end user such as a home owner, thus ensuring enough time for the newly inserted beverage cans/containers to either cool down/heat up to the desired best served temperature.

The dispensing device may also include one or more electronic operating condition sensor/s, capable of monitoring and electronically communicating one or more electronic information signals containing information of operating conditions of the dispensing device.

Operating conditions that would be monitored would typically be selected from one or a combination of any two or more of
the temperature inside of the hollow interior of the shell,
the temperature outside of the hollow interior of the shell,
the power usage of the dispensing device, and
the humidity inside of the hollow interior of the shell.

In respect of the power usage of the dispensing device, power usage at a particular point in time, total power usage over a period of time, power usage profile over a period of time, and average power usage over a period of time, are included.

The sensor/s may be configured to provide and communicate electronic information signals, including a stock information signal and, optionally, one or more operating condition information signals, containing information including stock information and, optionally, operating condition information detected by the sensor/s.

The dispensing device may further include at least one electronic communication device that is in electronic wire and/or wireless communication with one or more of the sensor/s. The electronic communication device may be configured to receive electronic information signals communicated by the sensor/s and may be capable of electronically communicating information contained in the electronic information signals received from the sensor/s. Such electronic communication may be in fresh electronic information signals, to other devices. Such other devices may include an electronic information processing device and/or an electronic information reporting device as described below with reference to the current aspect of the invention and/or with reference to the second aspect of the invention.

The electronic communication device may be an electronic communication device as described above, with reference to the electronic dispensing door controller.

The dispensing device may also include at least one electronic information processing device that is in electronic wire and/or wireless communication with the at least one communication device, to receive electronic information signals communicated by the at least one communication device.

The electronic information processing device may be capable of electronically processing information contained in the electronic information signals received from the communication device. In this sense, “processing” includes both storing the information contained in the electronic information signals received from the electronic communication device and creating new information using the information contained in the electronic information signals received from the communication device.

Typically, the electronic information processing device would be a computer processor.

The dispensing device may further include at least one electronic information reporting device that is in electronic wire and/or wireless communication with the at least one electronic information processing device and, optionally, with the at least one communication device, to receive electronic information signals communicated by the at least one information processing device and, optionally, by the at least one communication device.

The electronic information reporting device may be capable of visually reporting, i.e. displaying, information contained in the electronic information signals received from the at least one information processing device and, optionally, from the at least one communication device, or information based on information contained in the electronic information signals received from the at least one information processing device and, optionally, from the at least one communication device.

As such, the electronic information reporting device may include an electronic screen on which such information can be visually reported, i.e. displayed.

Further features of the electronic communication device, the electronic information processing device, and the electronic information reporting device may be as described in accordance with the system of the third aspect of the invention. In fact, in the embodiment of the system of the third aspect of the invention in which the dispensing device includes the electronic communication device and the electronic information processing device and the electronic information reporting device, the system of the third aspect of the invention may provide the dispensing device of the current, fourth, aspect of the invention.

In one embodiment of the invention, the dispensing device of the current, fourth, aspect of the invention, may be a dispensing device according to the first aspect of the invention. It would be appreciated that, in such an embodiment, the dispensing device would include the dispensing track as required by the first aspect of the invention, which may be the dispensing track as described above.

THE INVENTION EXTENDS, AS A SEPARATE ASPECT THEREOF, to the dispensing device of the fourth aspect of the invention, in use, in which a plurality of beverage containers, preferably cans, are located on and along the dispensing track in series, in the manner described according to the fourth aspect of the invention, in use.

THE INVENTION ALSO EXTENDS, AS A SEPARATE ASPECT THEREOF, to a method of operating the dispensing device of the fourth aspect of the invention, as characterised in respect of the fourth aspect of the invention, in use.

### BRIEF DESCRIPTION OF THE DRAWINGS

THE INVENTION WILL NOW BE DESCRIBED IN MORE DETAIL, with reference to the accompanying diagrammatic drawings.

In the drawings:

FIG. 1 shows, in three-dimensional view, one embodiment of a beverage container storage and dispensing device (“dispensing device”) according to the first and fourth aspects of the invention;

FIG. 2 shows, in side view, the dispensing device of FIG. 1;

FIG. 3 shows, in partially disassembled view, the dispensing device of FIG. 1;

FIG. 4 shows, in further partially disassembled view, the dispensing device of FIG. 1;

FIG. 5 shows, in still further partially disassembled view, the dispensing device of FIG. 1;

FIG. 6 shows, in one three-dimensional side-sectioned view, the dispensing device of FIG. 1;

FIG. 7 shows, in another three-dimensional side-sectioned view, the dispensing device of FIG. 1;

FIG. 8 shows, in bottom view, the dispensing device of FIG. 1;

FIG. 9 shows, in three-dimensional cross-sectioned view along A-A (see FIG. 2), the dispensing device of FIG. 1;

FIG. 10 shows, in plan view, the three-dimensional cross-sectioned view shown in FIG. 9;

FIG. 11 shows, in three-dimensional view, a dispensing door of the dispensing device of FIG. 1;

FIG. 12 shows, in partially open three-dimensional view, the dispensing door of FIG. 11;

FIG. 13 shows, in plan view, the dispensing door of FIG. 12;

FIG. 14 shows, in another three-dimensional view, the dispensing door of FIG. 12;

FIG. 15 shows, in yet another three-dimensional view, the dispensing door of FIG. 12;

FIG. 16 shows, diagrammatically, a beverage container storage and dispensing system (“dispensing system”) according to the invention.

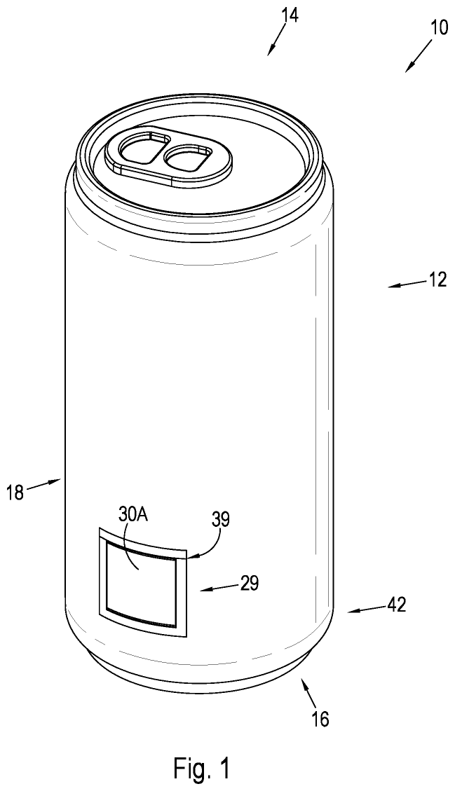

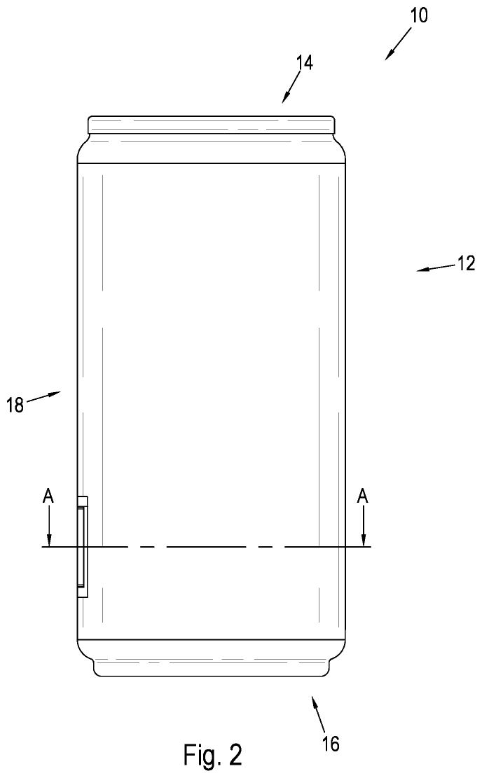

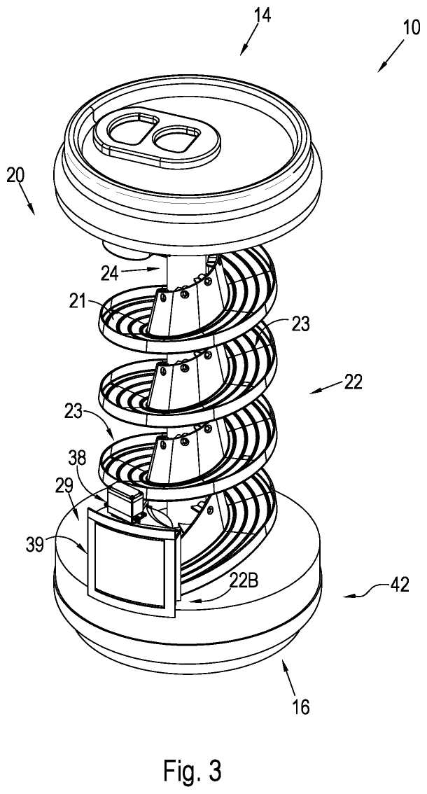

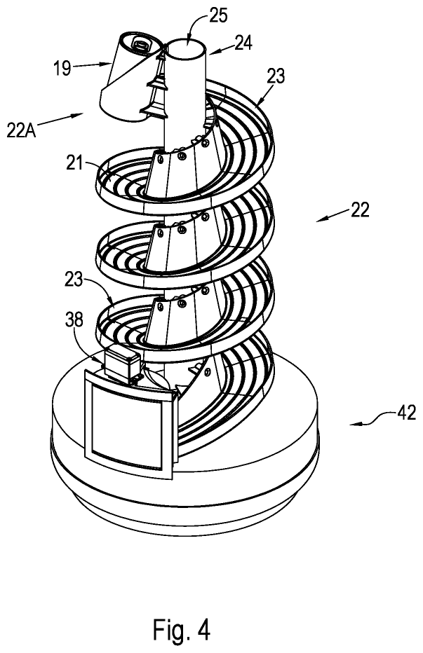

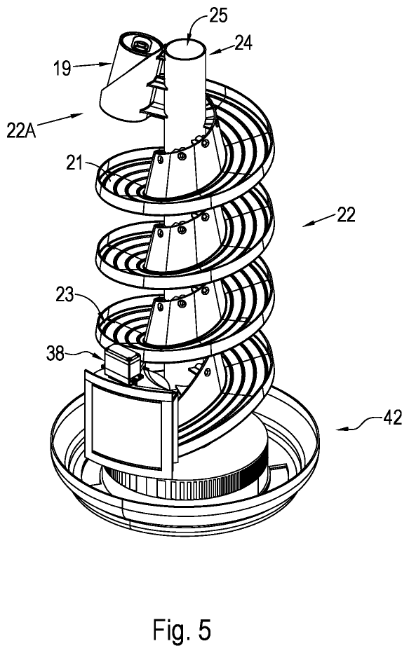

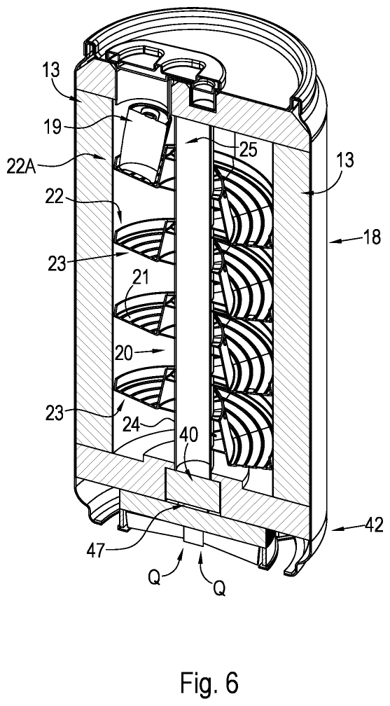

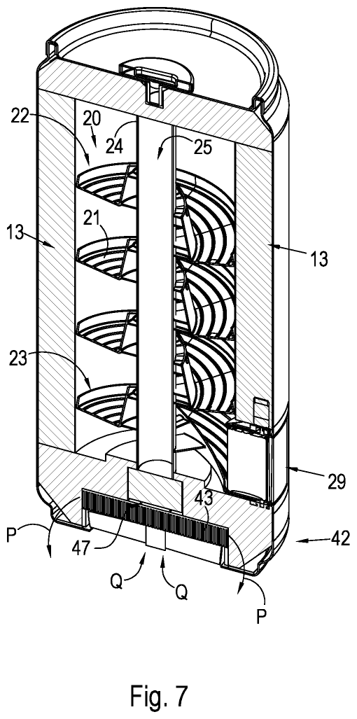

### DETAILED DESCRIPTION OF AN EXEMPLARY EMBODIMENT OF THE INVENTION

REFERRING TO THE DRAWINGS, reference numeral 10 generally indicates a beverage container storage and dispensing device (“dispensing device”) according to the first and fourth aspects of the invention.

It will be appreciated that, in accordance with the first aspect of the invention, a helical dispensing track is required, an example being the dispensing track 22 as described below with reference to the accompanying drawings, and, in accordance with the fourth aspect of the invention a dispensing door is required, an example being the dispensing door 29 as described below with reference to the accompanying drawings. In accordance with the first aspect of the invention, the dispensing door 29 as described below with reference to the accompanying drawings is therefore optional, but preferred, and in accordance with the fourth aspect of the invention the dispensing track 22 as described below with reference to the accompanying drawings is also optional, but preferred.

The device 10 includes a hollow shell 12. The shell has a closed top 14 and bottom 16, connected by a cylindrical sidewall 18. The shell 12 defines a hollow interior 20.

The sidewall 18 of the shell 12 is configured to locate a removable wrap, on which ornamental or informational representations, e.g. client or location branding, may be depicted. In this regard, although not clearly visible in the drawings, the sidewall 18 is slightly inwardly offset, i.e. sunken, relative to a rim of the top 14 and bottom 18 of the shell 12, thereby providing a circumferentially extending cavity complemental to such a wrap.

The shell 12 has a diameter of up to 50 cm, more preferably up to 40 cm, typically about 30 cm. In accordance with the invention, larger diameters apply as well, according to requirements.

As will be appreciated, in the illustrated embodiment, the shell 12 is can-shaped, i.e. resembles a beverage container in the form of a can. This is the preferred form of the device 10.

The shell 12 is thermally insulated, to assist in maintaining a desired temperature in its interior 20, with the assistance of a temperature control device as described below. In this regard, the shell 12 includes a thermal insulation layer 13 in the sidewall 18 thereof. The thermal insulation layer 13 is of a thermally insulating material, more specifically polyurethane. The thickness of the insulation layer 13 is selected depending on required efficacy and practical considerations, e.g. ease of handling, location and manufacturing of the dispensing device. The thermal insulation layer 13 has a thickness of up to 10 cm, more typically up to 5 cm.

In accordance with the invention, the insulation layer 13 may be omitted, in which case the space left by its omission would be a vacuum space to effect insulation.

Inside the interior 20 of the shell 12, a beverage container storage and dispensing track 22 (“dispensing track”) is located. The dispensing track 22 is configured, in the manner hereinafter described, to receive and thus locate, in use, a plurality of beverage containers, for example the beverage container 19, each containing a beverage, in series there along such that, in use, beverage containers located higher on the dispensing track move downwardly along the dispensing track when a beverage container located lower on the dispensing track 22 is removed from the dispensing track 22.

In accordance with the invention, the dispensing track 22 may be an integrally formed dispensing track, or an assembled dispensing track. In the latter embodiment, the dispensing track 22 would comprise sections that clip of bolt onto each other, to provide the dispensing track as illustrated. It would be appreciated that this flexibly allows the dispensing track to be configured to be of any desired length, and further allows greater ease of assembly and/or manufacturing.

In this regard, also in accordance with the invention, the shell 12, and more particularly its sidewall 18, may be an assembled sidewall, in that it comprises a plurality of assembled annular sections. It would be appreciated that this flexibly allows the dispensing track to be configured to be of any desired length, the magnitude of which would be dictated by the length/height of the dispensing track 22.

Such flexibility is regarded as an advantage of the invention.

The beverage container 19 is illustrated at a loading end 22A (see below) of the dispensing track 22. This is merely to illustrate where the loading end 22A is located. In use, a series of beverage containers would extend, instead, along the dispensing track 22 from an unloading end 22B (see below) thereof.

It will be appreciated that, being located inside the shell 12, the dispensing track 22 is isolated from surrounds of the shell 12, and access to beverage containers located along the dispensing track 22, from outside of the shell 12, in use, is thus restricted by the shell 12.

Turning to the configuration of the dispensing track 22, it would be noted from the drawings that, in accordance with the invention, the dispensing track 22 is helical and has a downwardly inclined helical floor 21. In a use configuration of the device 10, the dispensing track 22 is, as illustrated, substantially upright, extending in a spiralling manner between an operatively upper, or loading, end 22A and an operatively lower, or unloading, end 22B. In this sense, “loading” refers to the action of loading the dispensing track 22 with beverage containers and “unloading” refers to the action of unloading beverage containers from the dispensing track 22, in use. As would be appreciated from the description of the dispensing door, below, the action of unloading beverage containers from the dispensing track 22 does not necessarily amount to dispensing of beverage containers by the dispensing device 10. An additional step is required.

Being located in an upright configuration in use, and being helical, with the floor 21 downwardly inclined, movement of beverage containers along the dispensing track 22, in use, is under the force of gravity. Thus, under the force of gravity, unloading of a beverage container from the unloading end 22B of the dispensing track 22 would create a void at that end of the dispensing track, which would be filled by the next, remaining, beverage container, that would move into that space under the force of gravity, being urged in this regard by such movement of other remaining beverage containers. It would be appreciated that “remaining” in this sense means “remaining on the dispensing track 22”.

Thus, configuration of the dispensing track 22 is such that movement of beverage containers there along is under force of gravity. The dispensing track 22 is therefore configured such that it allows free movement of beverage containers downwardly there along, in series and under force of gravity, as beverage containers located lower on the dispensing track are unloaded from the dispensing track 22.

More specifically, in being configured to receive and thus locate, in use, a plurality of beverage containers in series there along, the dispensing track 22 defines a generally U-shaped (in cross section) channel 23 in which beverage containers would be located in use. The channel 23 is shaped and sized such that beverage containers can be located along the dispensing track 22 in series in a substantially upright configuration, referring in this regard to the depth and width of the channel 23. As would be appreciated, the channel 23 provides the floor 21.

The dispensing device 10 further includes a support structure 24 to which the dispensing track 22 is mounted. The support structure 24 is in the form of a hollow, elongate, cylindrical member, thus defining a hollow interior 25. The support structure 24 is centrally, i.e. co-axially, located with respect to the dispensing track 22. Thus, the dispensing track 22 extends in a spiralling manner around and along the support structure 24.

The support structure 24 is apertured along its length (the apertures are not illustrated), thus being capable of allowing air to pass along and through it. As described hereinafter in more detail, the support structure 24 plays an additional functional role in respect of heat transfer/cooling in the interior 20 of the shell 12, in use.

The dispensing device 10 further includes a dispensing door 29. The door 29 is located in a dispensing opening in the shell 12, near, and in fact adjacent to, the unloading end 22B of the dispensing track 22.

The door 29 includes a rotatable body 30 that is rotatably mounted in a seat/casing 39 that is immovably mounted in the sidewall 18 and insulation layer 13, for part-circular rotation of the body 30 about rotation axis “X” in the seat 39.

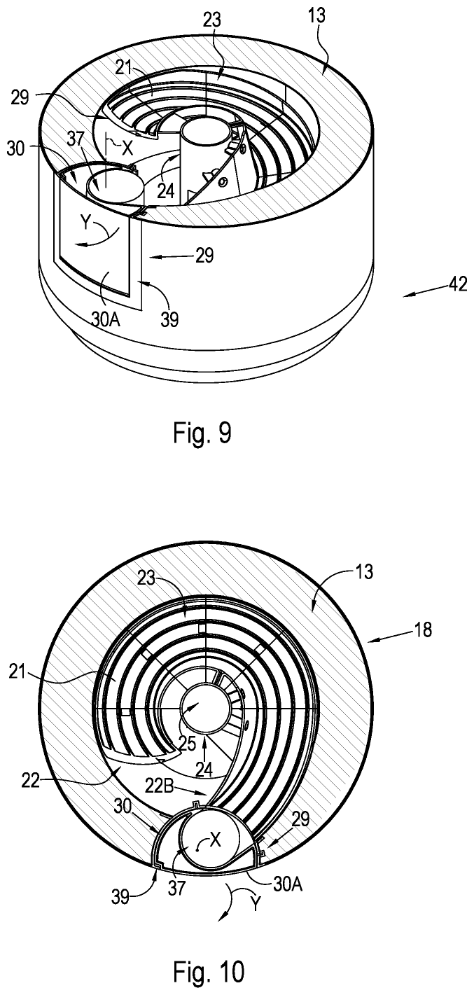

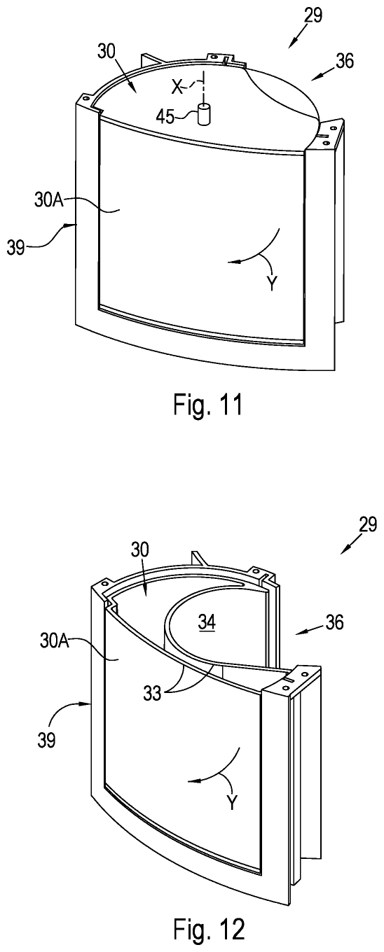

Rotatable mounting of the body 30 in the seat 39 is by means of oppositely located trunnions, of which only one trunnion 45 is visible, in FIG. 9. The other trunnion projects from the same position on a bottom of the body 30. The trunnions extend along the rotation axis X.

In a closed configuration of the door 29, as illustrated and as discussed below in more detail, a front 30A of the body 30 is substantially flush with an outer surface of the sidewall 18 of the shell 12.

The body 30 provides a beverage container locating formation 31 that, in turn, provides (i) a floor member 32 defining a flat surface 33 on which a beverage container can in use be located in an upright orientation in use and (ii) a wall member 34 defining, along with the floor member 32, a cavity 36 that is complementally shaped to a beverage container that would in use be located by the locating formation 31. In the illustrated embodiment, the beverage container is a can 37 (refer also to the can 19). Thus, the locating formation 31 is configured to accommodate a single beverage container, in the form of the can 37, at a time. The can 37 is only shown in some of the drawings.

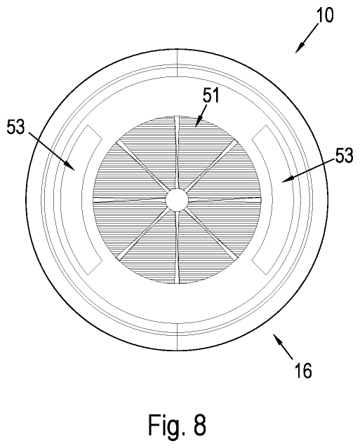

The dispensing door 29 is located (see FIG. 8 in particular) relative to the unloading end 22B of the dispensing track 22 such that the beverage container locating formation 31 can laterally receive, and thus be loaded with, a beverage container unloaded from the dispensing track 22 at the unloading end 22B of the dispensing track, due to lateral sliding movement of beverage containers along the dispensing track 22 under the force of gravity, in use, into the void of the cavity 36 when there is no beverage container located in it. It would be appreciated that once a beverage container is located in the cavity 36, that container would obstruct further movement of beverage containers along the track 22. In conventional operation, only removal of the beverage container located in the cavity 36 would create space for movement of beverage containers along the dispensing track 22 again to occur, provided that the empty cavity 36 is in register with the unloading end 22B of the dispensing track 22.

Being provided by the body 30 of the door 29, the locating formation 31 is movable as part of the body 30, i.e. movement of the locating formation 31, and therefore of a beverage container located by it in use, is effected by rotating movement of the body 30 about the axis X. Considering that the body 30 is mounted for rotatable movement about the axis X, movement of the locating formation 31, by movement of the body 30 about the axis X, would also be about the axis X.

In this respect, the body 30 is rotatably movable about the axis X, by rotatably moving the body 30, between
a closed configuration of the door, as illustrated, in which the locating formation 31 is located inside of the hollow interior 20 of the shell 12, thus preventing access, from outside of the hollow interior 20 of the shell 12, to a beverage container located on the locating formation 31 in use; and
a dispensing configuration of the door (not illustrated), in which the locating formation 31 is located outside of the hollow interior 20 of the shell 12, thus allowing access, from outside of the hollow interior 20 of the shell 12, to a beverage container located on the locating formation 31 in use.

It will be appreciated that, thus, in the dispensing configuration, the locating formation 31 would have been moved to take the place held by the front 30A of the body 30 in the illustrated closed configuration.

Movement of the body 30 about the axis X is allowed to such an extent that, in the dispensing configuration, the front 30A of the body 30 would separate the locating formation 31, and therefore a beverage container located on it in use, from the hollow interior 20 of the shell 12. Similarly, in the closed configuration, the front 30A of the body 30 separates the locating formation 31, and therefore a beverage container located on it in use, from surrounds of the shell 12. In this regard, the walls of the body 30 referenced as 33 would provide a separation formation according to the invention, which would effect such separation.

It is a feature of the invention generally that these walls 33 can be manufactured from either transparent low thermal conductive material such as polycarbonate, or any other transparent/non-transparent material. The walls can also be vacuum formed around the core 30 of the door, with either a vacuum created inside or low conductive gas such as Nitrogen inserted inside to decrease the heat transfer through the door walls 33 and front 33A. An advantage of being able to utilize transparent material such as polycarbonate, is that in presentation of the dispensing unit, the customer/end user now has the advantage of seeing the beverage can and its branding directly through the door front 30A. This effect can be enhanced with the use of one or more LED's being inserted behind and/or around the door seat 39.

The abovementioned separations are preferably such that there is virtually no air flow, and limited air communication, between the hollow interior 20 of the shell 12 and surrounds of the shell 12. This is, in the exemplified embodiment, achieved by including sealing members (not illustrated) in the dispensing device 10, which obstruct airflow through openings between the body 30 and the shell 12, through which openings air flow and air communication between the hollow interior 20 of the shell 12 and surrounds of the shell 12 would otherwise have occurred/have been possible. The sealing members are arranged such that they overlap openings between the door 29 and the seat 39 in both the closed and dispensing configurations, respectively in front of a portion of the body 30 and behind a portion of the body 30.

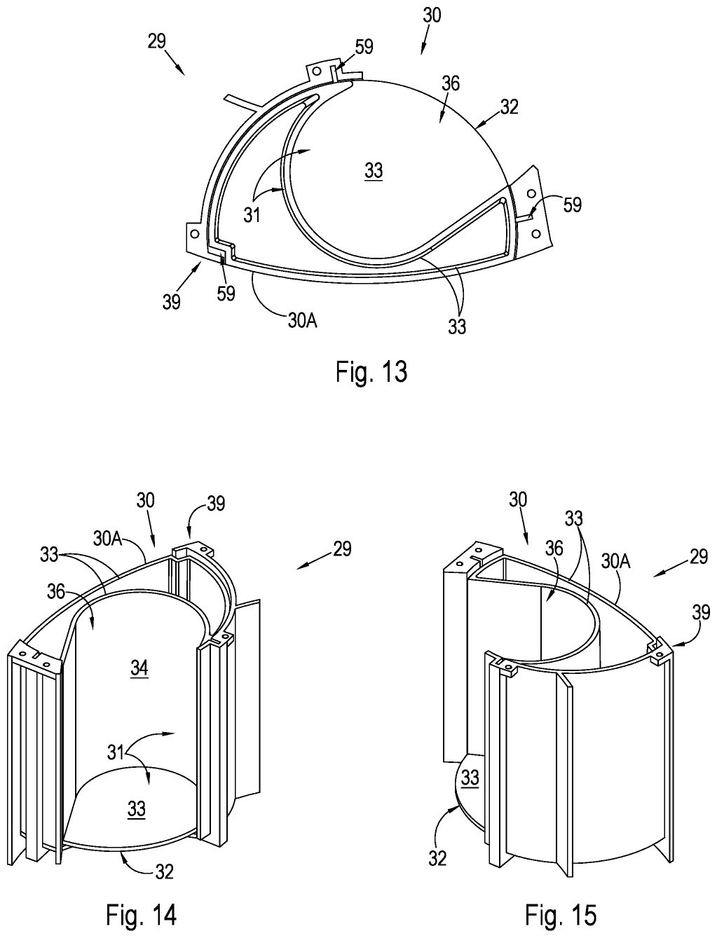

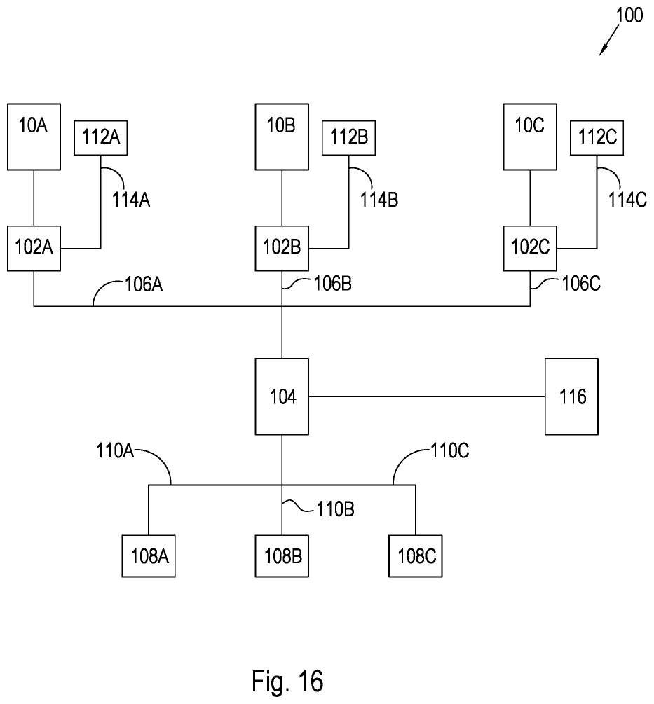

In the illustrated embodiment, sealing members would, in particular, provided in the three inwardly-open grooves 59 that are defined in the seat 39 of the door 29, on either side and rear thereof as seen in plan view in FIG. 13, adjacent to the small circular features.

Another method of achieving even less air flow between the hollow interior 20 and the shell 12 and surrounds of the shell 12, is to increase the thickness of the wall insulation 13 near/adjacent to the seat 39 of the door 29, such that as the body 30 of the door 29 is rotated about its axis X into the open dispensing position, the full door cavity 36 is never exposed to both the hollow interior 20 and the external surrounds of the shell 12 at the same time. The wider the insulation is against the edge of the seat 39 of the door 29, the more effective this method is, to the point that, provided that the seals mentioned above are fully effective, almost zero air movement between the hollow interior 20 and outer surrounds of the shell 12 will occur. In order to assist with this modification, the dispensing track unloading area 22B would need to be modified in its exact position.

Thus, when the body 30 is in the closed configuration, as illustrated, the locating formation 31, and more specifically the cavity 36, is in register with the unloading end 22B of the dispensing track 22. Thus, the dispensing track 22 effectively feeds beverage containers, one at a time, into the cavity 36 and thus onto the floor member 32, thereby to locate a beverage container moving along the dispensing track 22 under gravity by the locating formation 31, i.e. in the cavity 36 on the floor member 32.

Thus, a beverage container that would in use be at the front of the dispensing track 22 (i.e. at its unloading end 22B) would move, under gravity, into the cavity 36 defined by the locating formation 31 when the body 30 is in its illustrated closed configuration, thus being located inside the cavity 36, against the wall 34 and on the floor member 32.

By turning the body 30 into the dispensing configuration, in the direction of the arrow “Y”, the locating formation 31 is moved to take the place occupied by the of the front 30B of the body in the closed configuration, such that a beverage container located by the locating formation 31 is moved out of the hollow interior 20 of the shell 12 and is rendered accessible to a consumer.

In the same manner, the front 30A of the body is moved to where the locating formation 31 was previously located, with the front 30A and portions adjacent to it thus acting to obstruct further movement of beverage containers along the dispensing track 22.

It would be appreciated that, thus, the front of the body 30A and the locating formation 31 are moved from substantially diametrically opposite positions about the axis X to inverted substantially diametrically opposite positions in moving the body 30 to place the door 29 selectively in the closed and dispensing configurations.

By returning the body 30 to the illustrated closed configuration, the locating formation 31 is again brought into register with the unloading end 22B of the dispensing track 22, and thus a beverage container that has since moved to a front of the dispensing track 22, is unloaded into the, now empty, cavity 36.

The dispensing device 10 is configured for automatic movement of the body 30. In this regard, the dispensing device 10 includes an electronic dispensing door controller 38. The door controller 38 is configured selectively to allow and disallow, and to cause, movement of the dispensing door 29 from the closed configuration into the dispensing configuration, as described hereinbefore, by moving the body 30 about the axis X.

In order to cause movement of the body 30, the electronic dispensing door controller 38 includes a servo motor, operable to cause such movement. The motor is also operable to prevent such movement, and thus also provides locking means selectively to allow and disallow movement of the body 30.

The door controller 38 is further configured to require direct or indirect electronic communication of an electronic payment signal, indicating that payment has been made for one or more beverage containers to be dispensed, to cause movement of the body 30 from the closed configuration into the dispensing configuration.

In this regard, the dispensing device 10 includes an electronic communication device (not illustrated) that is in electronic wire and/or wireless communication with the door controller 38, the electronic communication device being operable electronically to communicate an electronic payment signal to the door controller 38.

In use, the electronic payment signal would be communicated to the electronic communication device by another device, such as an electronic information processing device, e.g. a computer, or a mobile electronic device, such as a cell phone, by means of which payment was made for one or more beverage containers to be dispensed from the dispensing device 10.

The dispensing device 10 therefore does not include means requiring physical payment to obtain a beverage from it, i.e. using payment means physically interfacing with the dispensing device to effect payment, such as a cash or physical token deposit, a credit card swipe, or the like.

The dispensing device 10 further includes a cooling device 47 that is located and operable to cool, or keep cool, the hollow interior 20 of the shell 12. Thus, the cooling device 47 would also cool, or keep cool, beverage containers that are in use located on the dispensing track 22, and the beverages contained by such beverage containers.

The cooling control device 47 is mounted to a metal (preferably aluminium) block 40 above it and a heat sink 43 below it. Bolts and insulating material are used to clamp the aluminium block 40 against the cooling device 47 and heat sink 43, and the aluminium block 40 is welded onto the base of the support structure 24. A fan (not visible) is attached to the heat sink 43 to effect airflow as described herein.

Alternatively, in accordance with the invention, the dispensing device 10 may include a heating device that is located and operable to heat, or keep heated, the hollow interior 20 of the shell 12. Thus, the heating device would also heat, or keep heated, beverage containers that are in use located on the dispensing track 22, and the beverages contained by such beverage containers.

In accordance with the invention, conditions that are regarded as “cooled” and “heated” respectively, would be determined as such relative to a reference temperature, which may, for example, be the ambient temperature outside of the shell 12 or a predetermined desired set point temperature.

The cooling/heating device 47 is hereinafter referenced by the term “temperature control device”, which term may be replaced with the term “cooling device” or the term “heating device”, whichever is relevant in the context. It is, in fact, preferred for the temperature control device to have both heating and cooling functionality, so that heating/cooling can selectively be effected. Cooling would be more typical than heating.

In the illustrated embodiment, the temperature control device 47 is a thermoelectric device, and more specifically a Peltier device.

The temperature control device 47 is located in an operative base 42 of the shell 12, below the dispensing track 22.

Desirably, although not in the illustrated embodiment, the temperature control device 47 may be located such that it delivers cooling/heating effect to a point close to the door 29, such that a beverage container located on the beverage container locating formation 31 in use is exposed to maximum cooling effect.

More specifically, in the currently illustrated embodiment, the temperature control device 47 is located such that it is functionally directed into the hollow interior 25 and immediate surrounds of the support structure 24 of the dispensing track 22. Thus, a cold side/hot side, as the case may be (cold side in the illustrated embodiment), of the temperature control device 47 is directed into the hollow interior 25 and immediate surrounds of the support structure 24.

Even more specifically, the cold side/hot side, as the case may be (cold side in the illustrated embodiment), of the temperature control device 47 is attached to the base of the support structure using:
a homogeneously welded or otherwise attached metal block, such as the metal block 40, to provide efficient heat transfer from the temperature control device 47 to the support structure 24;
a clamp with bolts to provide effective pressure and contact between the support structure 24 and the temperature control device; and/or
insulation material to prevent any heat transfer between the inside of the shell 12 and an area outside of the base where the temperature control device 47 is located.

Thus, the cooling/heating functionality of the temperature control device 47, i.e. cooling/heating of air inside the interior 20 of the shell 12, would be concentrated in the hollow interior 25 and immediate surrounds of the support structure 24, from which it would be distributed to the remainder of the interior 20 of the shell 12 through the apertures in the support structure 24. This is regarded as one of the advantages of the invention, in that an evenly distributed temperature control effect is thus obtained throughout the device 10, avoiding having a concentrated temperature-controlled area existing near the temperature control device 47 and the remainder of the interior 20 of the shell 12 being neglected. More specifically, temperature control is thus concentrated in a volume that extends along the length of the dispensing track 22, rather than at the unloading end 22B of the dispensing track 22, thus allowing for a more even distribution of the effect throughout the interior 20 of the shell 12.

This configuration is regarded as advantageous in effecting more even temperature control (i.e. cooling or heating) throughout the interior 20 of the shell 12, by concentrating temperature control in a limited volume along the length of the shell 12, in the interior 25 of the support structure 24, and then distributing it from there.

As mentioned, the temperature control device 47 rests on a finned heat sink 43. The heat sink 43 that includes a “sucking” fan/s and/or “blowing” fans (directly below the heat sink 43).

The sucking fan/s draw air in toward the heat sink 43, through vents 51 in the direction of the arrow “Q”, and then outward through vents 53 along and between the fins/vein lengths of the heat sink and back down in the in the direction of the arrows “P” which insures that the heated/cooled air (whichever the case may be) now moves laterally and outwardly away from the dispensing unit 10 and its walls 18. Similarly, blowing fans can be used to draw air in the opposite direction. Exit vents can be incorporated into the base 16 such that the removed air, be it hot/cold whatever the case may be, flows outward and away from the unit to avoid re-heating/re-cooling of the unit, whichever the case may be.

Operation of the temperature control device 40, particularly as a Peltier device, can be inverted in order to achieve a heating effect instead of a cooling effect inside the interior 20 of the shell 12. In such a case, the dispensing device 10 may include a heat sink which would typically be located operatively above the temperature control device 47, thus directing heat into the interior 25 and immediate surrounds of the support structure 24.

A fan can also be placed internally either:
inside the support structure 24 in the space 25, in either direction vertically up or down, allowing cool/hot air (whichever the case may be) to flow along the central inner length of the support structure and then through the apertures in the support structure and into the core area 20, thus allowing even further increased uniform temperature around from the bottom to the top and inner or outer areas of the core 20; and/or
between the support structure 24 and the unloading end 22B, directed straight at the can 37 currently seated within the cavity 36 to ensure the maximum cooling of the can ready to be first dispensed to the customer.

The following features of the dispensing device 10 are not illustrated in the accompanying drawings, but nevertheless are preferred features thereof and are therefore described as being included in the dispensing device 10.

The dispensing device 10 includes a beverage container loading zone, at which beverage containers are loaded onto the dispensing track 22. The loading zone is defined near the loading end 22A of the dispensing track 22. More specifically, the device 10 includes, in this regard, a loading port (not illustrated) in the top 14 of the shell 12. It will be appreciated that the dispensing device 10 thus provides a “top-loading” configuration.

The loading zone is configured, as a top loading zone, for delivery of beverage containers to the device by means of an unmanned aerial vehicle (UAV), also known more commonly as a drone. In this case, a quadcopter-type drone is envisaged. Thus, the device, and more particularly the shell, may have formations that can receive a drone, or more specifically a delivery formation of a drone, that is configured to carry and dispense, into the shell and onto the dispensing track, beverage containers carried by the drone.

The dispensing device 10 further includes
a dispensing door 29 status sensor that is capable of sensing, in use, whether the dispensing door 29 is in a condition that allows access to a beverage received by it, or not;
a proximity sensor that is capable of
   sensing whether the dispensing device is too close to any obstruction, object or person that may or may not be in nearby proximity to the device, and/or
   measuring the device's relative co-ordinates and/or position as compared to its original position before being required to dispense, refill with stock or examine by the intermediary vendor or end-user (this would be beneficial when utilizing the device with any space saving add-ons such as an extendable/retractable arm or displaceable cable attached to the device, capable of moving the device, e.g. between a stored and a dispensing position);
a camera inside and/or a camera outside of the shell 12, capable of transmitting, to a receiving device and, optionally, a video/photo display device and, optionally, a video/photo storage device, video or photo images from inside the interior 20 and/or outside of the shell 12;
a speaker, typically one to which a music playing device could connect with a Bluetooth™ interface, or a wi-fi interface, or a physical wire interface;
a global positioning system (GPS) device that allows for the position of the device 10 to be determined, preferably to a level of accuracy within a centimetre or two;
a sensor capable of detecting icing at/near the bottom of the device and of directing adjustment of the temperature of the device, to cause defrosting, the resulting water of which may be channelled to the heat sink to cause evaporation thereof and assist in cooling, with the device being configured accordingly; and
one or more USB and/or HDMI port to allow charging of mobile phones or to communicate with the electronic communication device and/or the electronic information processing device and/or the electronic information reporting device; and
a biometric interface device, such as a fingerprint reader, that validates the identity of a user for functional purposes, e.g. operation of the door.

The dispensing device 10 further includes a plurality of electronic sensors that detect information relating to the operation of the device 10 and its surrounds. More particularly, the dispensing device 10 includes an electronic stock sensor. The electronic stock sensor is capable of detecting and/or monitoring the number of beverage containers that are located on the dispensing track 22, and of electronically communicating an electronic information signal containing information of the number of beverage containers that are located on the dispensing track 22. In this sense, the term “number of beverage containers” must not be limited to a narrow interpretation of an exact number, although it includes such an interpretation. More broadly, however, the term should be understood as meaning that the electronic stock sensor is capable of monitoring and electronically communicating an electronic information signal containing qualitative information of the quantity of stock, i.e. beverage containers, in the dispensing device 10, e.g. that the level of stock has reached a predetermined point with reference to the absence of beverage containers in a particular section of the dispensing track 22 or the location of the last beverage container in a series arrangement of beverage containers on the dispensing track 22.

Thus, the electronic stock sensor is located and configured to detect and/or monitor the loading of the dispensing track 22 with beverage containers (i.e. its stock level), e.g. with reference to the number of beverage containers located on the dispensing track at any time and/or at a particular time, and/or that the number of beverage containers located on the dispensing track 22 has reached and/or is below a predetermined level/number.

The dispensing device 10 also includes a plurality of electronic operating condition sensors, capable of monitoring and electronically communicating electronic information signals containing information of operating conditions of the dispensing device 10.

Operating conditions that are monitored, and the operating condition sensors are therefore configured to monitor, include
the temperature inside of the hollow interior 20 of the shell 12,
the temperature outside of the hollow interior 20 of the shell 12,
the power usage of the dispensing device 10, and
the humidity inside of the hollow interior 20 of the shell 12.

In respect of the power usage of the dispensing device 10, power usage at a particular point in time, total power usage over a period of time, power usage profile over a period of time, and average power usage over a period of time, are included.

The sensors are configured to provide and communicate electronic information signals, including a stock information signal and one or more operating condition information signals, containing information including stock information and operating condition information detected by the sensors. The operating condition information communicated in the operation condition information signals include, in particular, operating condition information regarding
the temperature inside of the hollow interior 20 of the shell 12,
the temperature outside of the hollow interior 20 of the shell 12,
the power usage of the dispensing device 10, and
the humidity inside of the hollow interior 20 of the shell 12.

The dispensing device 10 further includes an electronic communication device that is in electronic wire and/or wireless communication with the sensors. The electronic communication device is configured to receive electronic information signals communicated by the sensors, and is capable of electronically communicating information contained in the electronic information signals received from the sensors. Such electronic communication includes communication to other devices, including an electronic information processing device and/or an electronic information reporting device as described below.

Preferably, the electronic communication device includes or is provided by the electronic communication device as described above, with reference to the electronic dispensing door controller 42.

The dispensing device 10 also includes an electronic information processing device that is in electronic wire and/or wireless communication with the electronic communication device, to receive electronic information signals communicated by the electronic communication device.

The electronic information processing device is capable of electronically processing information contained in the electronic information signals received from the electronic communication device. In this sense, “processing” includes storing the information contained in the electronic information signals received from the electronic communication device and creating new information using the information contained in the electronic information signals received from the electronic communication device.

The dispensing device 10 further includes an electronic information reporting device that is in electronic wire and/or wireless communication with the electronic information processing device and with the electronic communication device, to receive electronic information signals communicated by the electronic information processing device and by the electronic communication device.

The electronic information reporting device has a screen that is capable of visually reporting information contained in the electronic information signals received from the electronic information processing device and, optionally, from the electronic communication device, or information based on information contained in the electronic information signals received from the electronic information processing device and, optionally, from the electronic communication device.

One or more of the electronic communication device, electronic information processing device and electronic information reporting device may, optionally, be provided separate of the dispensing device 10, instead of forming part of it as currently described with reference to the device 10. In such a case, the device 10 would form part of a system according to the third aspect of the invention, for example being the system 100 described below.

Electrical components of the device 10 may be powered by any desired source of electricity. Most desirably, power may be supplied by a renewable source of electricity, e.g. solar generated electricity. As such, the device 10 may include a connection for connecting to a solar power source. Thus, the electricity source may be located remotely of the device 10. Alternatively, the electricity source may be incorporated into the device 10, e.g. it may be in the form of an electricity storage device such as a battery, or an electricity generation device such as a generator. When incorporated into the device 10, the electricity source would possibly need to be located such that it does not interfere with the work of the temperature control device, and/or would need to be insulated for this purpose.

The device 10 may also include mounting means, e.g. a hook, at its operative top 14, to allow for above-ground mounting of the device, i.e. such that it is not supported on its bottom 16 on a surface. For example, the device 10 may be suspended off the ground by a displaceable cable that engages the hook, and thus allows for the device 10 to be moved vertically, selectively to gain and prevent access to it. In this manner, space may be saved at an operative location of the device.

Alternatively, or in addition, the device 10 may also include mounting means, e.g. an extendable/retractable arm, attached either at its operative top 14, bottom 16, or somewhere along the sidewall 18 to allow for above-ground mounting of the device, i.e. such that the device 10 is not supported on its bottom 16 on a surface. For example, the device 10 may be suspended off the ground by an extendable/retractable arm that engages either the top 14, bottom 16 or sidewall 18, and is operable to move the device 10 vertically or sideways in any direction selectively to gain and prevent access to it, by respectively moving it into and out of reach of a user. In this manner, space may be saved at an operative location of the device.

Both in the case of a cable and/or an extendable/retractable arm, as described above, moving of the device selectively into and out of reach may be in response to an electronic displacement signal, in response to which such movement is effected. Such an electronic displacement signal would, for example, be communicated by a mobile device, such as a mobile telephone, to the electronic information processing device or to the electronic communication device of the device 10, which electronic information processing device or electronic communication device would be in operative communication with a controller of the cable and/or extendable/retractable arm, optionally via the electronic communication device in the case of the electronic information processing device, to communicate a displacement instruction to such a controller, thereby to cause it to move the device 10. Communication of an electronic payment signal may be a precondition for movement to take place.

The cable and/or extendable/retractable arm feature, as described above, applies to the invention generally, and is therefore not limited to the currently described and illustrated embodiment of the invention.

In the case of the cable and/or extendable/retractable arm feature, the proximity sensor may play a functional role in orienting the device and ensuring that the space into which it needs to move is clear, before it moves into that space.

Referring now to FIG. 14, reference numeral 100 generally indicates one embodiment of a beverage container storage and dispensing system (“dispensing system”) in accordance with the invention.

The dispensing system 100 includes three of the dispensing devices 10, referenced as 10A, 10B and 10C respectively.

Each dispensing device 10A, 10B, 10C has an electronic communication device operatively associated with it, these being referenced as 102A, 102B, 102C.

The dispensing system 100 further includes an electronic information processing device in the form of a server computer 104, located remotely of the dispensing devices 10A, 10B, 10C. As such, the sever computer 104 is also located remotely of the communication devices 102A, 102B, 102C.

The server computer 104 is hosted over the internet. It is in wireless electronic communication with each of the communication devices 102A, 102B, 102C respectively, over the internet, as represented by communication lines 106A, 106B, 106C.

The server computer 104 has memory in which it can store, electronically, information that is communicated to it, which specifically includes information as hereinafter described. The server computer 104 also has a processor, capable of processing, electronically, information that is communicated to it, optionally to create new information based, at least in part, on the information communicated to it.

The dispensing system 100 further includes electronic information reporting devices, in the form of cellular telephones 108A, 108B, 108C. The cellular telephones 108A, 108B, 108C are in wireless electronic communication with the server computer over the internet, as represented by communication lines 110A, 110B, 110C.

Each cellular telephone 108A, 108B, 108C carries a software program in the form of a mobile application (“app”) that securely operatively associates the respective cellular telephones 108A, 108B, 108C with respective dispensing devices 10A, 10B, 10C, through the server computer 104.

Thus, the app carried by cellular telephone 108A associates cellular telephone 108A with dispensing device 10A through the server computer 104, and restricts information that can be communicated to and reported by the app on cellular telephone 108A, to information associated with dispensing device 10A. The same applies to cellular telephones 108B and 108C, and dispensing devices 10B and 10C respectively.

The dispensing system 100 includes further information reporting devices, in the form of electronic screens 112A, 112B, 112C that are respectively in direct electronic wire communication with the communication devices 102A, 102B, 102C. Thus, the screen 112A is in communication only with the communication device 102A, to receive and report only information received from the communication device 102A. The same applies to screens 112B and 112C, and communication devices 102B and 102C. Communication is respectively along communication lines 114A, 114B, 114C.

The dispensing system 100 includes still a further electronic information reporting device, in the form of a supplier computer 116, that is in wireless electronic communication with the server computer 104, over the internet. The supplier computer 116 can access information relating to all of the dispensing devices 10A, 10B, 10C that is available on the server computer 104.

Finally, each of the dispensing devices 10A, 10B, 10C includes a stock sensor, that is capable of detecting the level of beverage container stock held by each dispensing device 10A, 10B, 10C, and further includes an interior environment temperature sensor (first temperature sensor), that is capable of measuring the internal environment temperature of each dispensing device 10A, 10B, 10C, and an exterior environment temperature sensor (second temperature sensor), that is capable of measuring the temperature of the environment external to each dispensing device 10A, 10B, 10C respectively.

The stock sensor and first and second temperature sensors of each dispensing device 10A, 10B, 10C are in electronic wire communication with the communication devices 102A, 102B, 102C of their respective dispensing devices 10A, 10B, 10C, to communicate by way of respective electronic information signals, including stock signals, first temperature signals and second temperature signals, stock information, first temperature information and second temperature information to the communication devices 102A, 102B, 102C, which then communicate this information to the server computer 104, to be stored in memory in the server computer 104, and/or to the respective screens 112A, 112B, 112C, to be visually displayed on the screens 112A, 112B, 112C.

Information stored in memory on the server computer 104 in relation to the dispensing devices 10A, 10B, 10C respectively, can be accessed by using the cellular telephones 108A, 108B, 108C respectively.

Stock information is, in certain circumstances, e.g. when the stock held by one of the dispensing devices 10A, 10B, 10C falls below a predetermined level, automatically communicated to one or both of the cellular telephone 108A, 108B, 108C associated with that dispensing device, and the supplier computer 116. Thus, both the user of the relevant cellular telephone 108A, 108B, 108C and the supplier are notified of the stock level falling below a predetermined level, prompting appropriate action.

It will be appreciated that in the abovementioned embodiment of the system 100, the cellular telephones 108A, 108B, 108C are, effectively, operator cellular telephones, that would be held by an operator of the dispensing devices 10A, 10B, 10C.

In another embodiment of the system 100, one or more of the cellular telephones, for example the cellular telephone 108A, would be held by a consumer. Such an embodiment is the subject of discussion in the next few paragraphs.

The app would, in such an embodiment, be configured to allow the consumer, from their cellular telephone 108A, to make a purchase of a beverage container, containing a beverage, located in one or more of the dispensing devices 10A, 10B, 10C.

The app may, for example, enable the cellular telephone 108A, through wireless communication, electronically to detect the proximity of one or more of the dispensing devices 10A, 10B, 10C, and thus present the consumer with an option of purchasing a beverage container, containing a beverage, from one or more of the dispensing devices 10A, 10B, 10C.

Alternatively, the app may allow the consumer to input the details of one or more of the dispensing devices 10A, 10B, 10C manually, and thus allow the consumer to make a purchase from the relevant dispensing device 10A, 10B, 10C.

The GPS devices inserted inside the units will also allow the controller computers 104 and 116 to know at any point in time where the units 10A, 10B and 10C are located, and if they have been moved or not. This will assist the drone or UAV to locate the units 10A, 10B and 10C and enable delivery of additional beverage containers for the refilling through the top 14 of the dispensing unit.

Having made the purchase, the app may, immediately or upon an instruction from the consumer to do so, cause the cellular telephone 108A to communicate, electronically, an electronic information signal, in the form of a payment signal, to the communication device 102A, 102B, 102C of the relevant dispensing device 10A, 10B, 10C, informing the communication device 102A, 102B, 102C of the purchase and thus causing the communication device 102A, 102B, 102C of the relevant device to communicate a “dispense” instruction to electronic door controller 38 of the relevant dispensing device 10A, 10B, 10C.

Thus, the electronic door controller of the relevant dispensing device 10A, 10B, 10C would cause the dispensing door 29 of the relevant dispensing device 10A, 10B, 10C to move from the closed configuration to the dispensing configuration.

The system 100 may also include a drone (not illustrated) which may be in direct or indirect communication with one or more of the electronic communication devices 102A, 102B, 102C to be notified of a low stock level and automatically to collect and deliver stock to the device 10.

### Discussion

THE INVENTION THUS PROVIDES a dispensing device that delivers, to a dispensing door, for consumer access, a beverage container, with such delivery being effected smoothly along a helical dispensing track, and in an upright configuration. This is in contrast to conventional vending machines which, in the case of beverages, typically dispense a beverage container by unloading it from a storage tracking a falling, uncontrolled manner, with such an unloaded beverage container typically lying on its side when presented for collection. Such unloading is significantly more controlled in the present invention.

The unloading/dispensing is also dramatically quieter in noise output. Typical noise range for modern fridge freezers is 32 to 47 dB, and anything quieter than 40 dB is considered a quiet model, as this is the noise level of a library. With the fan running at full power, the noise level of the final unit for manufacture is envisaged to be closer to 30 dB.

The helical configuration of the dispensing track is, further, space-effective in limiting the size of the dispensing device, while not prejudicing its capacity for holding beverage containers containing beverage. This holds true in particular when the external shape of the outer core 12 of the device is shaped cylindrical like a beverage can shape. Thus, the dispensing device is more compact than conventional vending machines, for example, while having a comparable capacity.

Furthermore, the configuration of the dispensing door, in allowing access only to a discrete number (and more specifically, one) of beverage containers at a time and, thus and in other respects such as through use of the sealing members, in limiting ingress of ambient air into the interior of the shell of the dispensing device, is regarded as particularly advantageous since it allows for more efficient temperature control inside the interior of the dispensing device. This is in contrast to conventional fridges that have doors that open to grant access to their entire contents, and thus allow a significant volume of cooler and warmer air to be exchanged between the interior of such a fridge and its surrounds, requiring more intensive intervention from a temperature control perspective.

The optional, but preferred, employment of a Peltier device in effecting cooling (or heating) is also regarded as advantageous from an energy efficiency perspective and space saving perspective, as is the possibility to invert its operation to provide both cooing and heating.

The dispensing system of the invention further ensures that information regarding its operating conditions and stock level is readily and continuously available, thus ensuring maintained stocking of the dispensing device and control of its operating conditions. As will be appreciated from the description of the invention, both operators of individual dispensing devices, respectively, and suppliers of dispensing devices, are able to access stocking information through the system and take appropriate action.

The advantages of the possibility to re-stock the device of the invention using a drone, allowed particularly because it is top loading, have already been discussed in the specification and are relevant here too.

Additionally, a major advantage is the light weight and minimal space/footprint that it takes up, and the ability to either be placed on a counter or against and/or between shelving or hung and operated from a roof in a space challenged retail, bar or home environment which is generally the case with most retail stores where suppliers battle for shelf space.

Further, the invention allows for exclusive and custom branding using customized sleeves around the core of the units. This provides low cost marketing in prominent merchandising position in or around the store front/counters.

Still further, the possibility for electronic, wireless payment for beverage containers to be dispensed from the device is regarded as being an added advantage, since it is computer-based and obviates the requirement for human intervention, e.g. by a barman that would usually be required to accept payment and provide beverage containers containing beverage in exchange for it.

A further advantage of the invention, is that, even though the design allows for uniform temperature control within all areas of the cavity, due to the can being dispensed at the bottom of the unit, only this temperature within the dispensing door becomes important, even if the rest of the can temperatures inside the unit are slightly non-uniform or inconsistent.

The applicant regards the dispensing device of the invention as an enabler of the system of the invention. Furthermore, the applicant sees the dispensing system of the invention as being an enabler of a more technically effective and commercially attractive business proposition than those offered by existing beverage storage and dispensing devices.

The applicant believes that the invention addresses a need for beverage retailing refrigeration space within stores, particularly where competition by less established brands with more established brands is challenging, since this space is usually owned and/or paid for by the established and/or large global beverage brands with significantly more resources than less established brands.

The applicant believes that the invention not only has a wide usage range and uniqueness in retailer/on seller stores such as bars, liquor, convenience, supermarket, restaurants and health stores for end user purchase or promotion, but it can also be purchase and used directly for home use by the end user in his/her home kitchen, bar or entertainment room.

Another significant aspect of the dispensing device is that it is designed such that green and/or environmentally sustainable and/or recyclable materials can be utilized in many of the parts of which it is constructed.

The dispensing device of the invention embraces the fourth industrial revolution in its use of “IOT” or Internet of things and automation and/or AI or Artificial Intelligence advanced learning, a way of the future.

Additional advantages of the invention as described have been discussed in the remaining text of the specification, and those are equally relevant to the invention generally.

1. A beverage container storage and dispensing device (“dispensing device”) for storage and dispensing of beverage containers containing a beverage, the dispensing device comprising
a shell that has a hollow interior; and
located inside of the shell, a helical beverage container storage and dispensing track (“dispensing track”) that extends in a spiralling manner around and along a central support structure, the dispensing track defining a channel that is configured to receive and thus locate, in use, a plurality of beverage containers, each containing a beverage, in a substantially upright configuration in series there along such that, in use, beverage containers located higher on the dispensing track move downwardly along the dispensing track when a beverage container located lower on the dispensing track is removed from the dispensing track.

2. The dispensing device according to claim 1, which includes a dispensing door that is located in a dispensing opening in the shell, near an operatively lower, unloading end of the dispensing track from which beverage containers can be unloaded from the dispensing track, wherein the dispensing door
provides a beverage container locating formation on which a beverage container can in use be located in a substantially upright configuration; and
is located relative to the unloading end of the dispensing track such that the beverage container locating formation can receive, and thus be loaded with, a beverage container unloaded from the dispensing track at the unloading end of the dispensing track, due to movement of beverage containers along the dispensing track.

3. The dispensing device according to claim 2, wherein the dispensing door is movable between
a closed configuration, in which the beverage container locating formation is located inside of the hollow interior of the shell, thus preventing access, from outside of the shell, to a beverage container located on the beverage container locating formation in use; and
a dispensing configuration, in which the beverage container locating formation is located outside of the hollow interior of the shell, thus allowing access, from outside of the shell, to a beverage container located on the beverage container locating formation in use.

4. The dispensing device according to claim 1, which includes a cooling device that is located and operable to cool the hollow interior of the shell.

5. The dispensing device according to claim 4, wherein
the central support structure is hollow, thus defining a hollow interior, and is apertured to allow fluid communication between the hollow interior of the central support structure and the hollow interior of the shell; and
the cooling device has a cold side that is directed into the hollow interior of the hollow central support structure.

6. The dispensing device according to claim 1, which includes one or more additional dispensing tracks located above the dispensing track, arranged in a stacked configuration relative to each other and relative to the dispensing track, each additional dispensing track being configured for transfer of beverage containers, located thereon in use, to the additional dispensing track or to the dispensing track that is located below it.

7. The dispensing device according to claim 1, which further includes
an electronic stock sensor, capable of monitoring and electronically communicating an electronic information signal containing information of the number of beverage containers that are located on the dispensing track of the dispensing device; and
optionally, one or more electronic operating condition sensors, capable of monitoring and electronically communicating one or more electronic information signals containing information of operating conditions of the dispensing device, selected from one or a combination of any two or more of
the temperature inside of the hollow interior of the shell,
the temperature outside of the hollow interior of the shell,
the power usage of the dispensing device, and
the humidity inside of the hollow interior of the shell.

8. The dispensing device according to claim 7, which further includes one or a combination of two or more of
an electronic communication device that is in electronic wire and/or wireless communication with one or more of the sensor/s, to receive electronic information signals communicated by the sensor/s, the electronic communication device being capable of electronically communicating information contained in the electronic information signals received from the sensor/s;
an electronic information processing device that is in electronic wire and/or wireless communication with the electronic communication device, to receive electronic information signals communicated by the electronic communication device, the electronic information processing device being capable of electronically processing information contained in the electronic information signals received from the electronic communication device; and
an electronic information reporting device that is in electronic wire and/or wireless communication with the electronic information processing device and, optionally, with the electronic communication device, to receive electronic information signals communicated by the electronic information processing device and, optionally, by the electronic communication device, the electronic information reporting device being capable of visually reporting information contained in the electronic information signals received from the electronic information processing device and, optionally, from the electronic communication device, or information based on information contained in the electronic information signals received from the electronic information processing device and, optionally, from the electronic communication device.

9. The dispensing device according to claim 3, which further includes an electronic dispensing door controller that selectively allows and disallows and, optionally, causes movement of the dispensing door from the closed configuration into the dispensing configuration.

10. The dispensing device according to claim 9, wherein the electronic dispensing door controller is configured to require direct or indirect electronic communication of an electronic payment signal, indicating that payment has been made for one or more beverage containers to be dispensed, to allow and, optionally, cause movement of the dispensing door from the closed configuration into the dispensing configuration.

11. A method of dispensing a beverage container, containing a beverage, from a dispensing device according to any of claims 1 to 10, which device contains a plurality of beverage containers containing a beverage, the method including
locating one of the beverage containers, or another beverage container, on the locating formation of the dispensing door of the dispensing device according to claim 3, in the closed configuration of the dispensing door;
moving the dispensing door from the closed configuration into the dispensing configuration; and
after collection of the beverage container located on the locating formation by a consumer, moving the dispensing door from the dispensing configuration into the closed configuration, thereby allowing or causing the beverage container locating formation to receive, and thus be loaded with, a fresh beverage container from the dispensing track, due to movement of beverage containers along the dispensing track.

12. The method according to claim 11, wherein the dispensing device is a dispensing device according to claim 7, and the method includes
electronically communicating one or more electronic information signals from the sensor/s to an electronic communication device;
by means of the electronic communication device, optionally being included in the dispensing device, which is then a dispensing device in accordance with claim 8, electronically communicating, in one or more electronic information signals, information contained in the electronic information signals received by the electronic communication device from the sensor/s, to an electronic information processing device, optionally being included in the dispensing device, which is then a dispensing device in accordance with claim 8;
by means of the electronic processing device and, optionally, the electronic communication device, one or both optionally being included in the dispensing device, which is then a dispensing device in accordance with claim 8, electronically communicating, in one or more electronic information signal/s,
information contained in the electronic information signal/s received by the electronic information processing device from the electronic communication device, and/or
information based on information contained in the electronic information signal/s received by the electronic information processing device from the electronic communication device, and/or
information contained in the electronic information signal/s communicated by the electronic communication device, to an electronic information reporting device, optionally being included in the dispensing device, which is then a dispensing device in accordance with claim 8; and
by means of the electronic information reporting device, visually displaying information
contained in the electronic information signal/s received by the electronic information reporting device from the electronic information processing device and, optionally, the electronic communication device, and/or
information based on information contained in the electronic information signal/s received from the electronic information processing device and, optionally, the electronic communication device.

13. The method according to claim 11, wherein the dispensing device is a dispensing device according to claim 10, and the method includes communicating, directly or indirectly, an electronic payment signal to the electronic dispensing door controller to allow and, optionally, cause moving of the dispensing door from the closed configuration into the dispensing configuration.

14. A beverage container storage and dispensing system, comprising
at least one dispensing device according to any of claims 1 to 11,
the system further including
an electronic communication device that is in electronic wire and/or wireless communication with one or more of the sensor/s, to receive electronic information signals electronically communicated by the sensor/s, the electronic communication device being capable of electronically communicating, in electronic information signals, information contained in electronic information signals received by the electronic communication device from the sensor/s;
an electronic information processing device that is in electronic wire and/or wireless communication with the electronic communication device, to receive electronic information signals electronically communicated by the electronic communication device, the electronic information processing device being capable of
electronically processing information contained in electronic information signals received from the electronic communication device, and
electronically communicating, in electronic information signals,
information contained in electronic information signals received from the electronic communication device, and/or
information based on information contained in electronic information signals received from the electronic communication device; and
an electronic information reporting device that is in electronic wire and/or wireless communication with the electronic information processing device and, optionally, with the electronic communication device, to receive electronic information signals communicated by the electronic information processing device and, optionally, by the electronic communication device, the electronic information reporting device being capable of visually reporting
information contained in electronic information signals received from the electronic information processing device, and/or
optionally, information contained in electronic information signals received from the electronic communication device, and/or
information based on information contained in electronic information signals received from the electronic information processing device, and/or
optionally, information based on information contained in electronic information signals received from the electronic communication device.
